(19) United States
(12) Patent Application Publication
(10) Pub. No.: US 2018/0324177 A1
(43) Pub. Date: Nov. 8, 2018

(54) Smart wearable devices

(71) Applicant: MEFON VENTURES INC., Burnaby (CA)

(72) Inventor: Shan WANG, Burnaby (CA)

(73) Assignee: MEFON VENTURES INC.

(21) Appl. No.: 16/015,177

(22) Filed: Jun. 21, 2018

Related U.S. Application Data
(63) Continuation of application No. PCT/CA2017/050153, filed on Feb. 9, 2017.
(60) Provisional application No. 62/293,730, filed on Feb. 10, 2016.

(51) Int. Cl. H04L 29/06; G06F 1/16; H04W 12/06; G06F 17/30; G02B 27/01; G02C 11/00

(52) U.S. Cl. CPC H04L 63/0861; G06F 1/163; H04W 12/06; G06F 17/30864; G02B 2027/014; G02B 27/0172; G02C 11/10; G02B 2027/0178; G02B 2027/0138; G06F 17/30244

(57) ABSTRACT

A method and apparatus for registering a user uses biometric authentication and authenticating the identities of interacting parties in real time. The method comprises receiving from a first computing device a captured data of a second computing device, and responsive to receiving the captured data, associating the captured data with data stored in memory to determine an identity of the user of the second computing device, and transmitting to the first communicating device the identity information of the second computing device, wherein the first and second computing devices have been registered with a server.

### CROSS-REFERENCE TO RELATED APPLICATIONS

This application is a continuation of International Patent Application No. PCT/CA2017/050153 with a filing date of Feb. 9, 2017, designating the United States, now pending, and further claims priority to U.S. Provisional Application No. 62/293,730 with a filing date of Feb. 10, 2016. The content of the aforementioned applications, including any intervening amendments thereto, are incorporated herein by reference.

### FIELD OF THE INVENTION

The present invention relates to nose-top wearable computing devices. In particular, the present invention relates to a series of hardware devices combined with sophisticated software to ensure smarter, safer, and more secure communications and the accurate searching of images or videos taken by the wearable computing devices via holistic online/Internet solutions.

### BACKGROUND OF THE INVENTION

E-commerce and online/Internet social network platforms have become an important part of modern life. Modern computing platforms require safety, security, and accuracy, especially when fighting against fraudulent, criminal, or terrorist activities conducted via computing devices.

There is demand for holistic systems capable of accurately and seamlessly authenticating the identities of interacting parties. Such a system would help to remove barriers in communications, thus facilitating mutual trust in personal interactions.

Various biometric technologies capable of recognizing unique biometric features of an individual have been developed. Such systems require that the features of the individual be captured and recorded so that the individual can be recognized at a later time whenever a specific purpose is required (e. g. accessing a particular authorized computer system, building or other facility, selling genuine products online, contacting emergency or rescue services, etc.)

A registration system interlocked with a wearable computing device that can reliably and accurately authenticate individual users is therefore desirable.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above described problems have been reduced or eliminated, while other embodiments are directed to other improvements.

This invention has a number of aspects. These include, without limitation:
Wearable computing devices with cameras and GPS positioning and instant uploading online communication capabilities;
Systems comprising wearable devices and databases configured to receive and store media acquired by and transmitted to the wearable computing devices;
Online systems for managing transactions mediated by the wearable devices; input, output and verifying including down- and uploading for processing and display;
A “Shared View” to allow registered users with the wearable computing devices to see simultaneously what other registered users are seeing;
Controlled opaque vision for keeping a healthy reading distance or a healthy viewing time so that the eyes are not over-tired;
A “See Thru” feature using specialized cameras (e. g. X-ray or other optical devices) to allow authorized persons to see and identify or eliminate masked suspects via related databases;
Online systems for managing media and access to media obtained by way of wearable devices and upload as programmed;
Methods for performing transactions mediated by wearable devices;
Biometric identification systems useful in wearable devices for verifying;
Methods and apparatus for indexing and retrieving genuine media;
Methods and apparatus for identifying people and genuine products online or offline alike;
Methods and apparatus for associating a computing device with a specific authenticated individual;
Methods and apparatus for authenticating a user's identity in order to access a user registered computing device for verifying purpose;
Methods and apparatus for verifying the identities of interacting users using user registered computing devices plus online connectivity;
Methods and apparatus for responding to emergency situations using wearable computing devices;
Methods and apparatus for monitoring the (most) wanted people (suspects) and/or unusual activities;
Computing devices configured to perform one or more of methods for registering the computing device; methods for authenticating a user's identity in order to access the user registered computing device; methods for verifying the identities of interacting users using the user registered computing device; and methods for activating an emergency signal upon detecting a dangerous situation and/or a criminal or terrorist using the user registered computing device;
Computing devices configured to authenticate media captured and uploaded by the device, and wherein the authentication information of each captured media may be embedded into the media itself, linked to genuine online source and may be visible when the media is displayed; and
Wearable devices comprising lenses having multiple functional layers, wherein the multiple functional layers may comprise one or more layers of a digital display screen, programmed transparency and a power source. In some embodiments the power source can be photovoltaic cells.

In accordance with one aspect of the invention, a method for registering a user with a wearable device comprises accessing a server; transmitting an identifier associated with the wearable device to the server; verifying, by the server, that the identifier corresponds to the wearable device; transmitting biometric information regarding the user to the server; transmitting an image of the user to the server; verifying, by the server, that the image of the user corresponds to the user; linking, by the server, the biometric information of the user with the wearable device; and receiving a message from the server indicating registration of the wearable device.

In another aspect of the invention, a method for authenticating a user of a particular wearable device comprises obtaining, by the particular wearable device, one or more biometric readings of the user; transmitting, by the particular wearable device, the one or more biometric readings to a server; verifying, by the server, that the one or more biometric readings correspond to stored biometric readings for the user, wherein the stored biometric readings for the user are specific to the particular wearable device; and transmitting, by the server, a message that the user is authenticated for the particular wearable device.

In a further aspect of the invention, a system for wireless communications between two or more users comprises a server, a database in communication with the server, and two or more devices. Each of the devices is associated with one of the users and comprises one or more sensors for capturing biometric information regarding the associated user and one or more transceivers for communicating wirelessly with the server. Each of the devices may be worn by the associated user. The database comprises data regarding stored biometric information for each of the users. Each of the devices is adapted to transmit the captured biometric information to the server to verify that the captured biometric data corresponds to the stored biometric information for the associated user.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic illustration outlining the system in accordance with an example embodiment.

FIG. 2 is a perspective front view of the wearable device according to an example embodiment.

FIG. 3 is perspective rear view of the wearable device according to an example embodiment.

FIG. 4 is a block diagram for most components of the wearable device according to an example embodiment.

FIG. 5 is a block diagram depicting an emergency mode of the wearable device according to an example embodiment.

FIG. 6 is a perspective front view of the wearable device according to an example embodiment.

FIG. 7 is a cross-section view illustrating the layers of the lens elements according to an example embodiment.

FIG. 8 is a schematic illustration outlining an example application of a system for registering the wearable device.

FIG. 9 is a flow chart of a method for registering the wearable device according to an example embodiment.

FIG. 10 is a flow chart of a method for authenticating a user's identity in order to access his/her wearable device according to an example embodiment.

FIG. 11 is a flow chart of a method for activating an emergency command using a wearable device according to an example embodiment.

FIG. 12 is a schematic diagram of an image captured by the wearable device according to an example embodiment regardless how the 4c5d metadata is arranged or sequenced and whether the 4c5d metadata can be seen by naked eyes.

FIG. 13 is schematic illustration of an image captured using the wearable device incorporating a digital watermark according to an example embodiment.

FIG. 14 is an enlarged illustration of FIG. 13 showing an example of a digital watermark.

FIG. 15 is schematic illustration of a second image captured using the wearable device incorporating digital watermarks according to an example embodiment.

FIG. 16 is an enlarged illustration of FIG. 15 showing the digital watermarks according to an example embodiment.

FIG. 17 depicts a method for verifying the identities of the interacting users using the wearable devices according to an example embodiment.

FIG. 18 depicts a method for activating an emergency signal upon detecting dangerous situation using the wearable device according to an example embodiment.

### DETAILED DESCRIPTION

Throughout the following description specific details are set forth in order to provide a more thorough understanding to people skilled in the art. However, well-known elements may not have been shown or described in detail to avoid unnecessarily obscuring the disclosure. Accordingly, the description and drawings are regarded in an illustrative, rather than a restrictive, sense.

One aspect of the present invention provides wearable computing devices that allow people wearing the devices to reliably identify one another. Each device is associated with a specific person. Each device uses biometric sensors to verify that it is being worn by the person with which the device is associated upon registration. The devices each include a wireless data communication facility that allows the devices to communicate with one another and an official database maintained by a trusted institution. The database contains certain information regarding the associated people with different ones of the wearable devices.

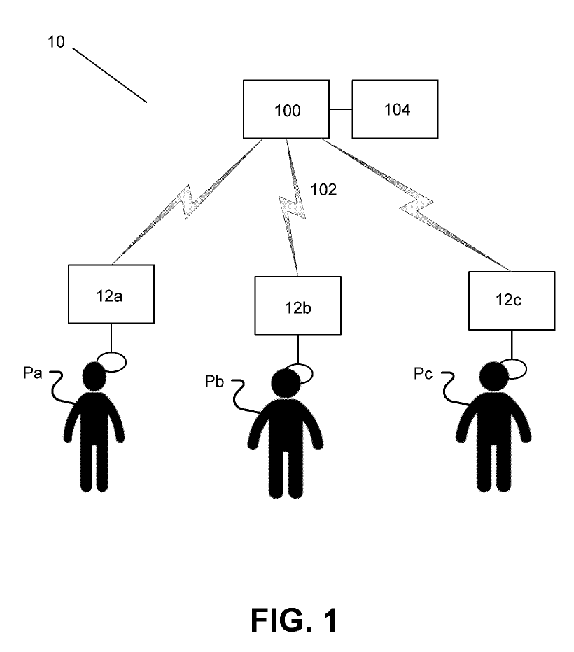

FIG. 1 is a schematic illustration illustrating an example application of a system 10 comprising one or more wearable devices 12. In this example embodiment, three wearable devices (12a, 12b, and 12b) are shown.

Each wearable device 12 is associated with a user P (i. e. Pa, Pb, and Pc shown in FIG. 1). Each wearable device 12 includes a biometric identification system that comprises one or more sensors. Sensors are preferably located on the wearable device 12 in locations where they can sense biometric characteristics of the user when the associated wearable device 12 is being worn by the user. The sensors may, for example, comprise sensors such as acoustic sensors, ultrasonic sensors, infrared sensors, imaging sensors, or vibration sensors, as described later. The sensors may sense biometric characteristics such as features of the user's pulse, features of the user's skeletal structure, features of the user's voice waves, features of the user's eyes (e. g. iris or retina patterns), features of the user's bioelectrical signals, features of the user's breathing, body and/or skin temperature measurements, galvanic skin response, fingerprint scanning, facial structure, or combinations of these. All of these features are intended to ensure that each activated wearable device 12 is associated or interlocked with only one user, unlike conventional smart phones that may be used by multiple people.

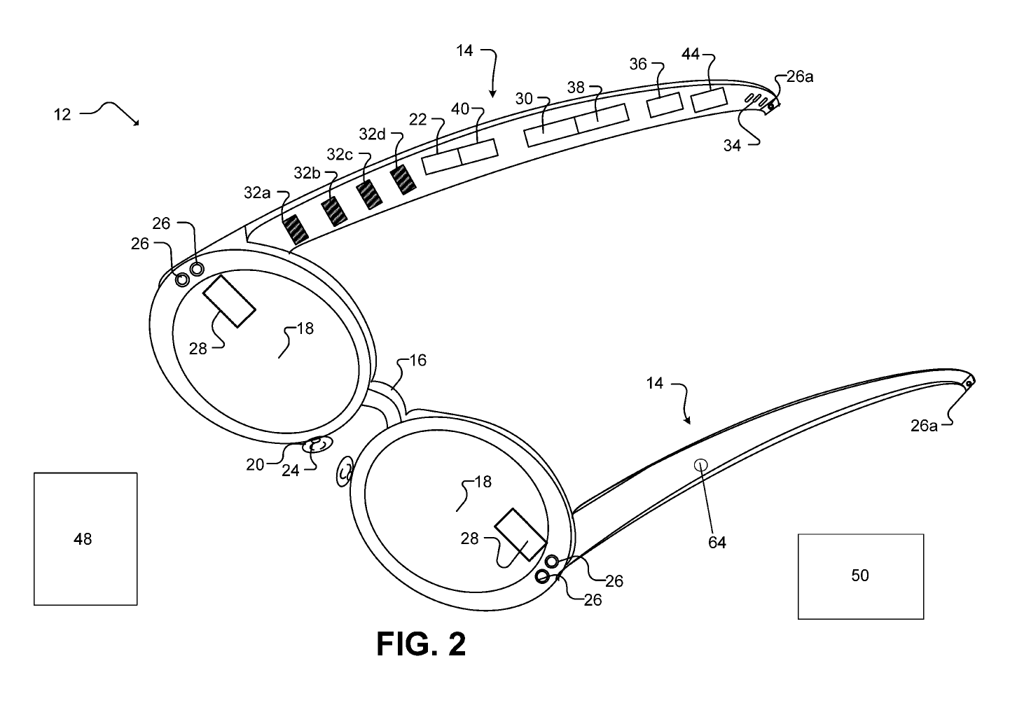

FIG. 2 shows an example of one embodiment of the wearable device 12. In this embodiment, the wearable device 12 takes the general form of a set of eyeglasses. However, wearable devices 12 may take other forms, such as watches, wristbands, clothing, and the like.

In the embodiment shown in FIG. 2, the wearable device 12 comprises two arms 14 extending from a central frame 16. The central frame 16 supports two lens elements 18. Preferably, pads 20 are attached to a lower portion of the central frame 16 and engage the nose of the user when the wearable device 12 is worn.

The wearable device 12 comprises one or more processors 22. The processors 22 may be located on one or both of the arms 14 (as shown in FIG. 2); however, it is to be understood that the processors 22 may also be located on other portions of the wearable device 12.

The wearable device 12 also comprises a transceiver 30 for transmitting data to and receiving data from a server 100 (as shown in FIG. 1). Preferably, the transceiver 30 communicates wirelessly over a network 102 with the server 100, as shown in FIG. 1. Such communications may be using one or more of known protocols, such as Wi-Fi, Bluetooth, cellular transmission such as 4G, 5G, LTE, etc. The server 100 may be connected to a database 104. The transceiver 30 may be located on one or both of the arms 14 and is in communication with the processor 22.

Pads 20 preferably comprise a microphone 24. In one embodiment, the microphone 24 is a bone conduction microphone; however, other types of microphones are also possible. Bone conduction microphones are operable to sense and pick up sound vibrations from the nasal bone, which are then converted into electrical signals that are transmitted to the processor 22 for processing.

The user may enter voice commands using microphone 24. The processor 22 may include a speech recognition program comprising a dictionary of predetermined commands for controlling various functions of the wearable device 12. For example, when the user enters a voice command into microphone 24, the processor 22 may, using the speech recognition program, identify the commands entered by the user and take the appropriate action. Alternatively, the processor 22 may deny carrying out the command if it recognizes that the user's identity has changed. This enhances the safety and security of the wearable device 12 in the event that the wearable device 12 is stolen or worn by authorized persons.

Microphone 24 is preferably highly sensitive and may have a high signal-to-noise ratio. Therefore, in emergency situations, the user wearing the wearable device 12 may quietly issue a voice command via microphone 24 in a manner such that others would not notice or hear.

Lens elements 18 may comprise a clear lens or a prescription lens. In some embodiments, lens elements 18 may be detachable and interchangeable. For example, the user may switch the lens elements 18 between a clear lens and a reversed touch screen display lens that allow the user to touch command icons with his or her finger on the outer surface of the lens elements 18 (as described later). The opacity of lens elements 18 may also be controllable, such as by using a photo-chromatic lens. This may be controlled using voice commands, by pressing appropriate buttons, or by eyeball tracking technology.

The wearable device 12 preferably comprises a plurality of cameras 26 that are in communication with processor 22. In the embodiment shown in FIG. 2, cameras 26 are mounted on the central frame 16. The user may capture images and/or videos in the user's field of view by using the cameras 26. Some or all of the plurality of cameras 26 may also be mounted at any other suitable positions on the wearable device 12. For example, some of the cameras 26 may also be mounted alongside arms 14 (e. g. at the ends of arms 14, such as 26a in FIG. 2). In such embodiments, the user may capture images and/or videos of objects that are located at the sides or rear of the user's field of view, in addition to images and/or videos of objects located in periphery of the user's field of view.

Images or videos from cameras 26 that are rear-facing (e. g. cameras 26a) may record images or videos that can be transmitted to the processor 22 and then displayed on one or both of the lens elements 18 (as described later). In this manner, the user can see both in front and behind simultaneously.

Cameras 26a may be useful for preventing unexpected attacks from behind. Victims are typically attacked from the back due to the lack of ability to naturally see from behind. For example, if the user wearing the wearable device 12 suspects that he or she is being followed, the user may command the wearable device 12 to turn on the one or more cameras 26a and begin capturing and uploading images and/or videos. Such photos may be automatically or manually instructed to be transmitted through network 102 to relevant authorities via the server 100 (as described later).

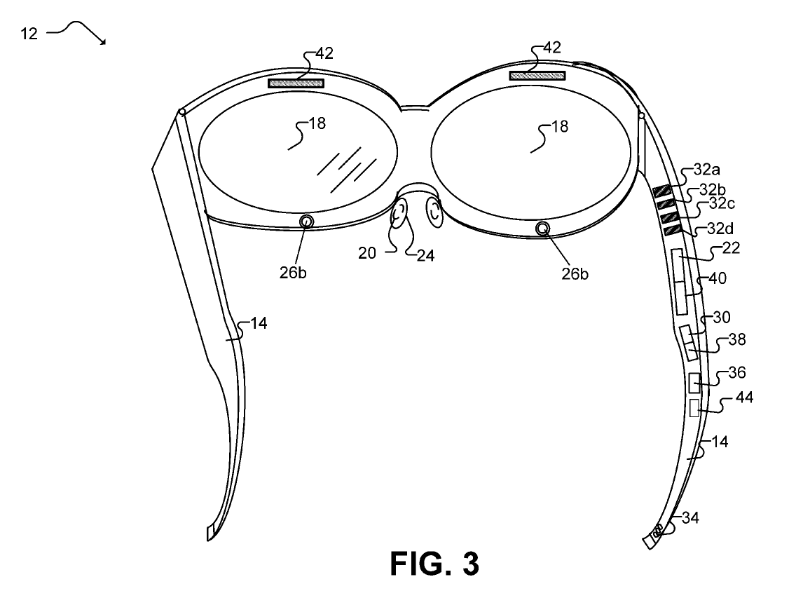

Images or videos from the one or more cameras 26a may also be displayed to the user (e. g. on a portion of lens elements 18). Referring to FIG. 2, the lens elements 18 may comprise miniature screens 28 for displaying images or videos from cameras 26a to the user. The miniature screens 28 may be located at different positions on lens elements 18 (e. g. at different corners or edges of lens elements 18). Cameras 26 may also be located on an inner surface of the central frame 16 such that they are able to detect iris or retina patterns or track eyeball movement (e. g. cameras 26b on FIG. 3).

In some embodiments, the cameras 26 may have night vision and/or telescopic functionality. Cameras 26 with night vision are operable under very low lighting conditions. Such cameras are sensitive to infrared radiation and have an infrared imaging mode that permits the user to view and record scenes in complete darkness. The cameras 26 may also comprise a flash and/or IR light emitter for improving the quality of images or video.

Cameras 26 may comprise a window for light to enter from, at least one camera lens, which respectively include at least one camera lens elements for light passing through, and an image sensor for capturing the light. In some embodiments, cameras 26 may provide a zoom function by software and/or hardware means. In such embodiments, captured images may be magnified by the user through software process or through hardware zoom with further lens driving units operable to adjust the distances of one camera lens element at least relative to the image sensors to achieve the desired zoom in focus.

Cameras 26 may be switched on or off by user command. In some embodiments, the user may issue a voice command via microphone 24. In other embodiments, the user may provide a command by touching lens elements 18.

Arms 14 may comprise a plurality of sensors 32. For illustrative purposes, four sensors 32a, 32b, 32c, 32d are shown in FIG. 2. However, arms 14 may comprise any number of sensors 32. Sensors 32 may be biometric sensors operable to detect heart and breath rates, body or skin temperatures, galvanic skin response, fingerprint scanning, voice recognition, facial structure, or a combination thereof. Such sensors 32 may be used as identifiers to lock a particular registered user to the wearable device 12. Sensors 32 may also comprise one or more microphones operable to receive ambient sounds. The sensors 32 are in communications with the processor 22.

The wearable device 12 may also comprise one or more speakers 34 to output audio. In the embodiment shown in FIG. 2, the speakers 34 are situated proximate to the ends of arms 14, such that they are located close to the user's ears when the wearable device 12 is worn. However, speakers 34 may be mounted at any suitable location on the wearable device 12. For example, some or all of speakers 34 may be mounted close to the user's temples and/or the user's nose.

Speakers 34 may be conventional audio speakers, bone conduction speakers, or transducers. In embodiments in which speakers 34 are bone conduction speakers, they may convert the output signals into vibrations that may be transferred to the bone structure of the user.

The wearable device 12 may further comprise a global positioning system (GPS) component 36, which may be located on one or both of the arms 14. The GPS component 36 may be operable to provide the location of the wearable device 12. The GPS component 36 may also be operable to provide navigational instructions based on the user's current detected location or the user's intended destination. In some embodiments, the wearable device 12 may not include the GPS component 36, but may communicate wirelessly with another wearable device 12 that does include a GPS component 36 for determining the location of the user or for providing navigational instructions to the user upon request.

The wearable device 12 also comprises a battery 38. The battery 38 may be connected to the various other components on the wearable device 12 (such as the processor 22, sensors 32, speakers 34, cameras 26, microphone 24, etc.) to power their function. The battery 38 may be charged in various ways, such as by solar power, kinetic energy, wireless charging, wired charging, or the like.

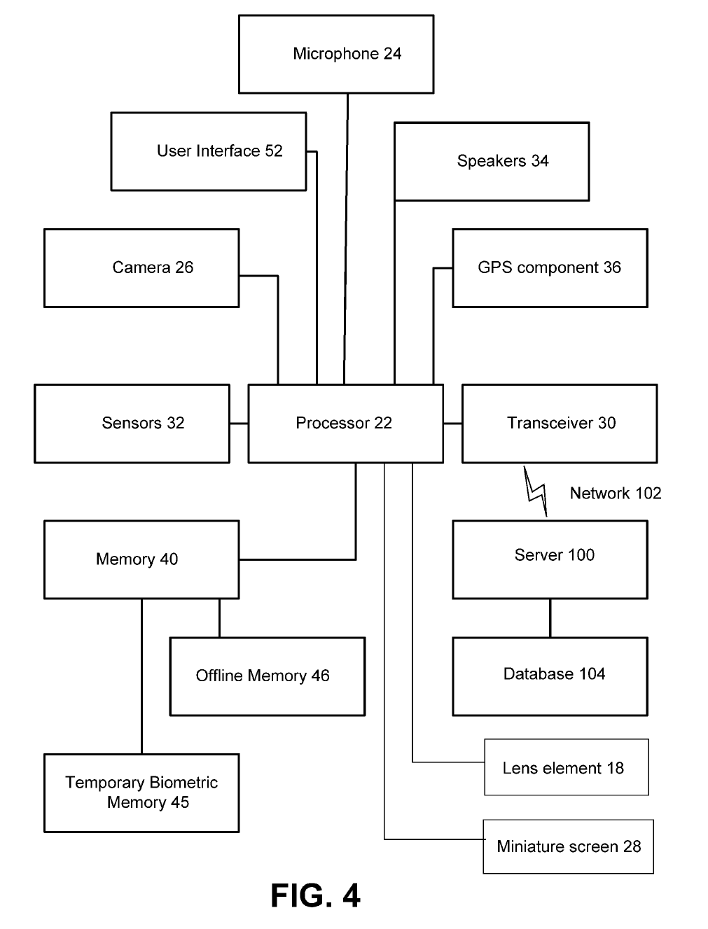

The processor 22 may also be coupled to data storage such as memory 40. For example, memory 40 may be used to store software, such as the real-time authentication software, that can be executed by the processor 22. In the embodiment shown in FIG. 2, the processor 22, the memory 40, the battery 38, and the transceiver 30 are mounted on or inside one or both of the arms 14. The processor 22 may be in either wired or wireless communications with the other components (e. g. sensors 32, speakers 34, cameras 26, microphone 24, lens elements 18, miniature screens 28, etc.) of the wearable device 12, as shown generally in FIG. 4.

In some embodiments, one or more sensors 32 may be configured to detect movements of the user's head when the user is wearing the wearable device 12. This allows users to ensure that the orientation of the wearable device 12 is levelled so that the captured images or videos are also levelled. This feature may additionally be applied to detect commands made through head or hand gestures of the user apart from any anti-vibration technology in the cameras 26.

One or more sensors 32 may also comprise a tilt sensor (e. g. 32a). The tilt sensor 32a may comprise one or both of accelerometers or gyroscopes. In some embodiments, the wearable device 12 is adapted to notify the user of the tilt of the wearable device 12. Referring to FIG. 3, notification displays 42 are mounted on the inside surface of the central frame 16, located generally above each lens elements 18. Such a configuration allows the user to visually see any notifications on notification displays 42 when the user glances upwards. For example, notification displays 42 may emit a blinking red light when the one or more tilt sensors 32a senses excessive tilt of the wearable device 12. Excessive tilt of the wearable device 12 may be preprogrammed to be defined as a tilt angle of more than, for example, 25° from horizontal. In some embodiments, notification displays 42 may emit a green light when the one or more tilt sensors 32a senses that the wearable device 12 is not tilted (e. g. when the tilt angle is less than or equal to 25° from horizontal).

Such embodiments optionally monitor outputs of tilt sensors 32a to detect patterns of motion. Commands may be triggered by a user tilting his or her head in a particular way.

In some embodiments, the wearable device 12 may comprise a vibrating motor 44 configured to notify the user when the wearable device 12 is excessively tilted. For example, when the one or more tilt sensors 32a detect an excessive tilt of the wearable device 12, the processor 22 transmits a message to the vibrating motor 44 to cause the wearable device 12 to vibrate to notify the user of the excessive tilt. The vibrating motor 44 may be included in addition to notification displays 42.

In some locations or situations, the ability for wearable device 12 to connect to network 102 may be compromised. In such situations, wearable device 12 may enter a “disconnected mode” in which certain protocols override its standard protocols. For example, where wearable device 12 compares measured biometric data of the user against authenticated biometric data stored in database 104 (as described later), it may no longer be able to do so in when in “disconnected mode”. Therefore, wearable device 12 may be configured to store any captured biometric data in a temporary biometric memory 45 that is part of the memory 40, as illustrated in FIG. 4. Once wearable device 12 exits “disconnected mode” and is able to connect again to server 100, the data in the temporary biometric memory 45 can be used for verification purposes by the server 100. In this way, all offline data can be verified to ensure that no tampering occurred while in “disconnected mode”.

The user may be alerted when wearable device 12 enters “disconnected mode” and may be instructed on how to regain a connection to network 102. For example, the user may be provided with the last known location where the connection to network 102 was strong and the closest location where the connection can be found. In some embodiments, the user may be alerted when he or she is about to enter a location with historically poor connectivity. The user can also be reminded where to go for a stronger connectivity.

Wearable device 12 may be configured to take additional biometric readings, images, or recordings while in “disconnected mode” to readily upload once connectivity is regained. In this way, if something happens when wearable device 12 is in “disconnected mode”, the relevant authorities would have a greater amount of information to work with. In the event that the wearable device 12 is stolen, this can be re-verify the authenticity of the registered user so that anyone stealing the wearable device 12 would be not be able to use or sell it. Alternatively, the wearable device 12 can also be triggered to enter “stealth mode”, as described later.

The wearable device 12 is preferably configured to record images, audio, or video to the memory 40 even if the wearable device 12 is in “disconnected mode”. Such images, audio, or video may be stored in an offline memory 46 that is part of memory 40. Once connection is re-established, the wearable device 12 uploads the images, audio, or video automatically to the server 100 to the user's designated account.

In addition to the functions above, the wearable device 12 may provide an “emergency mode”. When the “emergency mode” is triggered by a command (such as voice command or touch command or gesture command or eyeball tracking command, etc.), the wearable device 12 obtains and transmits information, preferably including still and/or moving images, location information (e. g. GPS coordinates) and audio to server 100 through network 102. This information may be stored in database 104 under a “restricted” section of the user's account, to which not only the relevant authorities have access, but also any user-preset relatives, friends, colleagues, etc. In one embodiment, they are able to see what the user is seeing through “Shared View”. In the event that the user cannot contact assistance directly, these people can act on the user's behalf.

“Shared View” allows certain user-preset persons to access the “restricted” section of the user and to see what the user is seeing (as captured by the cameras 26). Referring to FIG. 1, if, for example, user Pa is the daughter of user Pb and Pc, then if user Pa triggers “emergency mode”, the “Shared View” feature may be automatically activated so that users Pb, Pc can see what is captured by the cameras 26 on user Pa's wearable device 12.

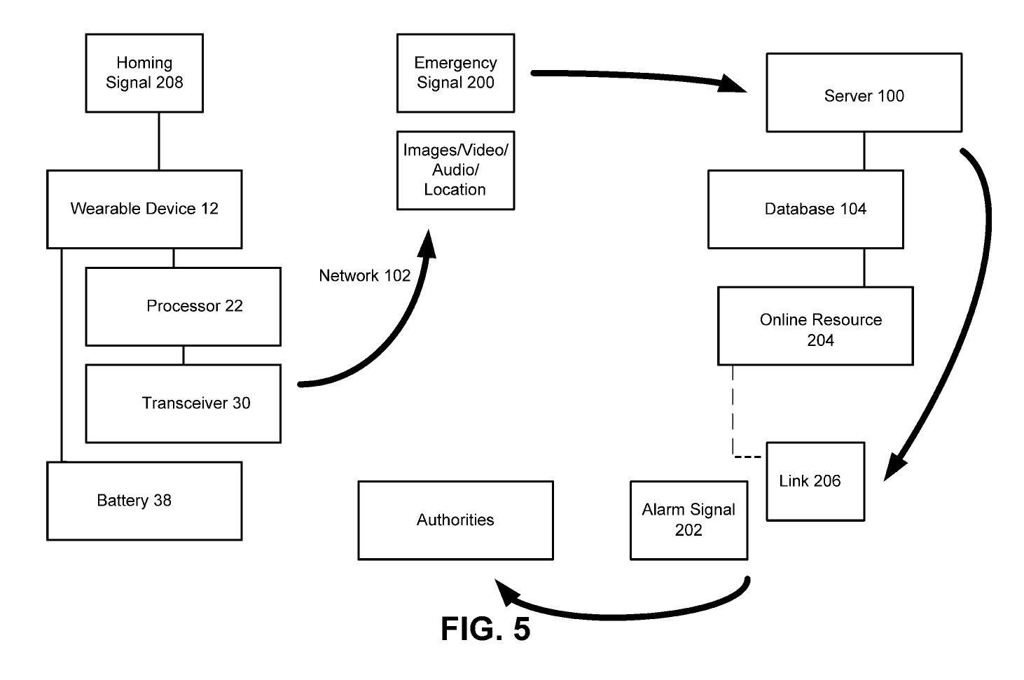

On entering “emergency mode”, wearable device 12 may also transmit an emergency signal 200 to server 100 via network 102, as depicted in FIG. 5. The emergency signal 200 may cause server 100 to generate an alarm signal 202 to be transmitted to the relevant authorities. The alarm signal 202 may be accompanied by information from the wearable device 12, indicating the user's name, current location, and recorded images or videos. The relevant authorities (or any user pre-set persons) can act according to the alarm 202.

Upon receiving the emergency signal 200 indicating that the wearable device 12 has entered “emergency mode”, the server 100 may automatically create an online resource 204 containing data that may be pertinent to the relevant authorities and provides a link 206 to the online resource 204. Link 206 may be included in the alarm signal 202. The online resource 204 may comprise a web page, a FTP source, a Dropbox™ folder, or any other possible storage.

The relevant authorities (e. g. the police) may transmit voice or data messages to the user's wearable device 12. Since the wearable device 12 is pre-set to only function for the user that is registered for the wearable device (as described later), there is no danger that these messages will be transmitted to the wrong person.

While the wearable device 12 is in “emergency mode”, the wearable device 12 may also trigger a “stealth mode”. In some embodiments, “stealth mode” is triggered when the wearable device 12 detects that it is no longer being worn by its registered user. In “stealth mode”, the wearable device 12 may appear to be off or may have its transmitting functions disabled, but is in fact continuing to transmit video, still images, audio, and/or location information. While in “stealth mode”, the wearable device 12 may also emit a locally detectable homing signal 208 so that relevant authorities can locate the last spot where the user left the wearable device 12.

A separate wireless battery 48 (see FIG. 2) may also be used in conjunction with the wearable device 12. The wireless battery 48 automatically charges the battery 38 when the charge in the battery 38 becomes low (e. g. lower than 20%). The battery 38 may be pre-set with at least 10% power preserved for emergencies. The processor 22 may include a battery management process that automatically tapers off the frequency and amount of data transmission over time in order to extend operations in “emergency mode” or “stealth mode”. The processor 22 may also generate pre-set alarm signals to alert the user whenever the wireless battery 48 away from the wearable device 12 beyond a pre-set distance (e. g. beyond 5 metres).

The wearable device 12 can be temporarily disabled for recording images or video within the range of a blocking unit 50 (see FIG. 2) to prevent the users of wearable devices 12 from recording material, such as movies in theatres or recordings of lectures or examinations or recordings of business meetings. Blocking units 50 may broadcast data signals that are signed using a private key associated with system 10 (of FIG. 1) such that the blocking function can only be triggered by blocking units 50 that are a part of, or authorized by, system 10. The blocking function preferably does not block recording of images, video, or audio while the wearable device 12 is in “emergency mode” as described above.

Blocking units 50 (as shown in FIG. 2) may each comprise GPS functionality and be authorized by system 10 only for use in certain preregistered locations. A blocking unit 50 may be configured to emit blocking signals only when it is within these authorized locations.

The wearable device 12 may have different user interfaces 52 (as shown in FIG. 4) providing different levels of functionality. Different embodiments may provide:
Indicator-only interfaces (e. g. a small LED lamp and/or alphanumeric display visible to the user);
Audio interfaces (e. g. noises, pre-recorded speech, and/or synthesized speech, voice commands, etc.);
Visual interfaces, e. g. eyeball tracking commands;
Graphical interfaces, which may be superposed on or beside a view through lenses of the wearable device 12; and
Tactile interfaces (e. g. interfaces that communicate to a user by applying touches, pressures, vibrations, temperatures, combinations of these to a user's skin).

The user interface 52 (shown in FIG. 4) may include a display that is integrated with lens elements 18. In some embodiments, the lens elements 18 provide one or more of the following functions:
Power acquisition (e. g. by way of solar cells incorporated into the lens elements 18);
Variable light transmission;
Power storage (e. g. by way of transparent electrical storage devices incorporated into the lens elements 18);
Display functionality (e. g. by way of LCD, LED and OLED incorporated into one or both lenses and/or images projected onto one or both lens elements 18 and/or prisms/light reflectors incorporated into one or both lens elements 18); and/or
Control input functionality (e. g. by providing a touch sensor on outer surfaces and/or edges of one or both lens elements 18 or via eyeball tracking system).

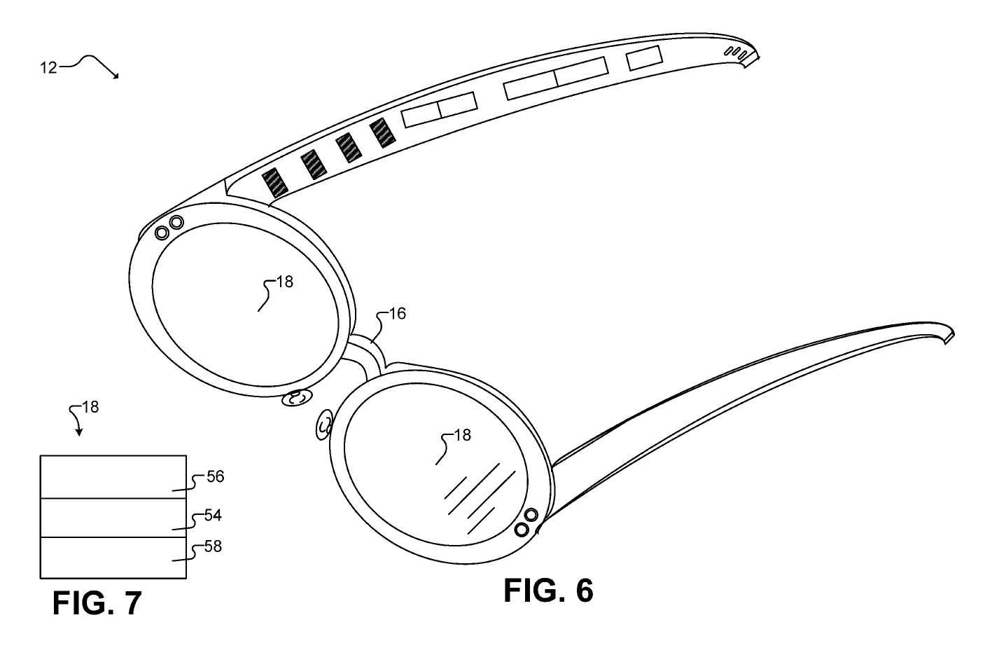

In some embodiments, the lens elements 18 comprise multiple layers. Referring to FIG. 7 (which is a cross-sectional view of the lens elements 18 of FIG. 6), the layers may include one or more layers of a lens power source 54, one or more layers of a substrate 56, and one or more layers of a display screen 58.

The one or more layers of a lens power source 54 are adapted to generate electrical power for the wearable device 12. The lens power source 54 may be transparent such that user can see through the lens power source 54. The one or more layers comprising the lens power source 54 may be positioned adjacent to the layers comprising the display screen 58 and/or the substrate 56 such that the layers substantially touch and overlap each other.

As best seen in FIG. 7, the display screen 58 is preferably positioned at an inner surface (i. e. closest to the user's eye) of the lens elements 18, the lens power source 54 is preferably positioned adjacent to the display screen 58 on a side opposite to the inner surface, and the substrate 56 is preferably positioned adjacent to the lens power source 54, such that the lens power source 54 is mounted between the display screen 58 and the substrate 56. This particular order of positioning of the layers is not mandatory, however.

The substrate 56 is preferably transparent or substantially transparent. It may optionally attenuate light that passes through it, and/or lens elements 18 may comprise a layer or a coating that attenuates light. Substrate 56 may comprise any suitable materials such as plastic, glass, polycarbonate, and/or the like. In some embodiments, substrate 56 is shaped and designed to provide a prescription lens.

The lens power source 54 may comprise a solar battery, such as a photovoltaic cell. The photovoltaic cell may comprise a thin-film photovoltaic cell. In some embodiments, the solar battery may comprise a thin film comprising a transparent conducting oxide (TCO) such as, e. g. Indium tin oxide (ITO), Zinc-oxide (ZnO), and impurity-doped ZnO such as Ga-doped zinc oxide (GZO) and Al-doped zinc oxide (AZO). In some embodiments the TCO comprises graphene which may be in the form of a graphene sheet, be a single layer or multi layers stacked on top of one another alike.

In the embodiments where the lens power source 54 is a photovoltaic cell, the photovoltaic cell may be combined with an electro chromic material (i. e. materials that are operable to change the opacity of the lens from optically transparent to opaque by applying an electrical voltage across the layers of the combined battery) that may selectively vary the balance of colors transmitted through the lens elements 18. The lens elements 18 will revert back to their optically transparent state upon reversing such electrical voltage. The outer layer of lens elements 18 may turn automatically to a “sunglass” effect one a pre-set light intensity (e. g. 500 lux) is exceeded. It may also turn back to normal transparency when the light intensity is lower than the pre-set light intensity.

The user may control the wearable device 12 to apply or reverse this voltage manually. For example, the user may send a signal to change the color and/or optical transparency of the lens elements 18 as desired. Upon receiving such a command, the wearable device 12 is adapted to apply or reverse the electrical voltage. The color or/and optical transparency of the lens elements 18 may also be programmed to change depending on lighting strength. For example, whenever the intensity of the ambient lighting exceeds 500 lux, the color and/or optical transparency may become dark or less transparent so that the user's eyes can be protected. The user may change the level of intensity for triggering the change as desired.

The wearable device 12 may also be configured to apply or reverse the voltage when predetermined illumination level(s) provided by a light source is sensed by one of the sensors 32 mounted on the wearable device 12. In some embodiments, the photovoltaic cell acts both as a power source and as a light sensor. For example, the predetermined illumination level to apply the voltage may be set at 500 lux or greater, and the predetermined illumination level to reverse the voltage may be set at 100 lux or less. Thus, if the sensor 32 on the wearable device 12 senses that the illumination level has reached at least 500 lux, the wearable device 12 is configured to apply the electrical voltage to change the color of the lens elements 18 to opaque. The lens elements 18 remain opaque until the sensor 32 senses that the illumination level is less than 500 lux. In such case, the wearable device 12 may be configured to reverse the electrical voltage to revert the color of the lens elements 18 to become near transparent or transparent (e. g. 90 to 100% transparent). In some embodiments, when the sensor 32 senses that the illumination level is less than a threshold amount (e. g. 100 lux), the wearable device 12 is configured to switch the one or more cameras 26 to a night vision low light mode so as to increase their sensitivity to light.

The lens elements 18 may provide different levels of opacity. For example, the lens elements 18 may exhibit different levels of opacity depending on the illumination level detected by the sensor. In one example, when the detected illumination level reaches 300 lux, the lens elements 18 will be set at 50% opacity (i. e. approximately 50% of the light is transmitted and approximately 50% of the light is blocked), and when the detected illumination level reaches 500 lux, the lens elements 18 will be set at 90% opacity.

When the lens elements 18 are changed to be opaque, the photovoltaic cell absorbs and converts the solar energy into electrical energy. The amount of solar energy that is absorbed depends on the level of opacity of the lens elements 18. The photovoltaic cell is connected electrically to the battery 38. The converted electrical energy is supplied from the photovoltaic cell may be used to charge the battery 38 or light the display screen 58 automatically.

In some embodiments, the lens power source 54 may comprise a photovoltaic coating. The photovoltaic coating may be transparent and include, for example, carbon nano tubes, carbon fullerene, and graphene. Such compounds are energy storage materials that are operable to absorb light of different wavelengths and to convert the absorbed solar energy into electrical one. The electrical energy may then be supplied to the battery 38.

The display screen 58 may comprise several layers of materials so as to provide liquid crystal display (LCD), a light-emitting diode (LED) display, or, in particular, an organic light-emitting diode (OLED) display. The display screen 58 may comprise a transparent OLED display. The several layers of materials that may be used to provide the OLED display may include, for example, ITO, Indium Zinc Oxide (IZO), ZnO, and the like. The transparent OLED display device may comprise a single layer or multi layers of graphene sheets. The display screen 58 may comprise layers of flexible materials and thus may be flat or curved.

In some embodiments, the transparent OLED display emits light from only one side of the layers of materials when the device is illuminated. This means that contents will only be displayed on one side of the lens elements 18. In such an embodiment, the OLED display may emit light towards the inner surface, in the direction of the user's eyes when the user is wearing the wearable device 12. Therefore, only the user wearing the wearable device 12 will be able to view the contents displayed on the display screen 58 (see FIG. 7). The lens elements 18 may comprise a background layer. The background layer may be positioned at a front side of the display screen 58. The front side of the display screen 58 is more proximate to the outer surface than the inner surface. The wearable device 12 may be configured to darken the color of the background layer. In some embodiments, the color of the background layer may be changed totally to dark, allowing the user wearing the wearable device 12 to view the contents displayed on the display screen 58 against a black background (e. g. similar to the effect in a cinema).

In some embodiments, the transparent OLED display emits light from both sides of the layers of materials when illuminated. This means that contents can be displayed on both sides. In such an embodiment, not only the user wearing the wearable device 12 can view the contents displayed on the display screen 58 from the inner surface, others positioned in front of the user may also view the contents displayed on the display screen 58 from the outer surface of the wearable device 12, but in an opposite left and right mirror effect. It is also possible to provide a first OLED display that provides a display viewable by the user and a second OLED display that provides a display viewable from the outside. These displays may provide different information or patterns. In some embodiments, the outward-facing display provides aesthetic stylish images that may be fixed or may change over time. The user may optionally have a control that allows the user to select different effects for display on the outward-facing display.

When the OLED display is not illuminated, the lens elements 18 may be optically transparent or near-transparent. The user can thus use the wearable device 12 as prescription glasses, sunglasses, or merely as an accessory for use as a communication device such as for wireless telecommunication.

The display screen 58 may comprise reversed touch screen functionality, providing a touch control panel which permits the user to control the operations of the wearable device 12 by touching an external side of the display screen 58. The external side of the display screen 58 is at the outer surface of the wearable device 12. The touch control panel may detect single and multi-touch actions such as one or more of tap, hold, scroll, press and pinch. When the user touches the external side of the display screen 58, the touch control panel detects the action, and generates a signal in response to the touch. The signal is then processed to determine the location of the touch. The location of the touch is then correlated to the specific user command in accordance with the function displayed on the touch screen. To prevent the reversed touch screen from being dirtied by fingers, the screen may be sprayed by a nano material, making it water or dirt repellant.

The battery 38 is preferably a rechargeable battery that may be recharged by connecting the wearable device 12 to a power supply (either through a wired connection or wirelessly). Battery 38 may be operable to provide a main supply of power to the operation of the wearable device 12. In some embodiments, the lens power source 54 may be operable to provide the main supply of power to the display screen 58 or the operation of the wearable device 12. Battery 38 may comprise any suitable type of batteries, including but not limited to, lithium-ion batteries, alkaline batteries, sodium-sulfur batteries, and the like. In some embodiments, the battery 38 may comprise one or more layers of graphene sheets.

Operation of the system 10 will now be described. The system 10 can verify the identity of the user wearing the wearable device 12 based on readings from the sensors 32. This can be done by comparing a value or set of values derived from the sensor readings to a reference value or set of values previously obtained for the user. The system 10 may be configured to verify the identity of the user wearing the wearable device 12 periodically or continuously so that any other user cannot access the wearable device 12. Wearable devices 12 are preferably in wireless communication with the server 100.

The reference value(s) corresponding to the authorized user of the wearable device 12 may be stored in the wearable device 12 itself (e. g. burnt into firmware in the wearable device 12 when the wearable device 12 is assigned to the authorized user) and/or stored in database 104. Database 104 may also comprise information about the authorized user of each wearable device 12. For example, the database 104 may contain the authorized users' name, contact information, medical information, and other authenticated information associated with the authorized users. Preferably, this information may not be accessed by other persons unless proper permission is given.

System 10 may be configured to provide functionality that allows an authorized user of one wearable device 12 to obtain the identity of the authorized user of another wearable device 12 in a trusted way. This functionality may be provided by a combination of hardware and software distributed in various ways between the wearable devices 12 and server 100. System 10 uses biometric identification via sensors 32 to ensure that the identification is trusted.

For example, the wearable devices 12 may be configured to exchange information about their respective authorized users (e. g. to confirm the identity of one user in near proximity to another user). This exchange may occur automatically when the wearable devices 12 are in close proximity to one another or when a user of one wearable device 12 causes that wearable device 12 to send a request for identity of the user of another wearable device 12. The wearable device 12 may be configured to require authorization from the authorized user before information about the authorized user is provided to the user of another wearable device 12. For example, system 10 may rely on visual and/or audio recognition to receive instructions to share such identity information.

Referring to FIG. 1, first user Pa is the authorized user of wearable device 12a and second user Pb is the authorized user of wearable device 12b. When user Pa initializes sensors 32 on wearable device 12a to obtain biometric information about user Pa, a verified status of wearable device 12a is inhibited until the biometric information determined from sensors 32 has been determined to match the reference information for user Pa. This initialization step may be performed every time wearable device 12a is taken off and put back on such that others can trust that whenever wearable device 12a is being worn and is operating with the verified status set, the person wearing the wearable device 12a is actually the authorized user Pa. Similarly, others can trust that whenever device 12b is being worn and is operating with the verified status set, the person wearing the wearable device 12b is actually the authorized user Pb (the same for wearer Pc for wearable device 12c, etc.).

Various aspects of functionality of wearable devices 12 may be inhibited unless the verified status is set. This provides protection against wearable devices 12 being stolen or getting into the wrong hands since wearable devices 12 could be rendered useless to anyone other than the authorized user. In some embodiments, the lens elements 18 of wearable devices 12 may be configured to be opaque and/or to display an outwardly visual indicator (such as a message saying “THIS HARDWARE IS STOLEN”) unless the verified status is set. Other features that may be selectively disabled depending on whether the verified status is set are features such as:
access to credentials for logging into server 100;
access to credentials for decrypting logs or other locally-stored information;
access for credentials for decrypting and/or encrypting communications to and from server 100;
operation of user interface controls; and/or
operation of a display, audio system or other user interface elements.

In another embodiment, other aspects may continue to function even when the verified status is not set. For example, the ability to contact emergency services through wearable device 12 may continue to function to allow a bystander to contact emergency services. Similarly, cameras 26, microphone 24, and GPS component 36 may continue to function for tracking purposes as long as the user can identify himself or herself upon request by emergency services and explain why his or her identity is different from that of the authorized user.

Whenever the wearable device 12a is in close proximity to another wearable device 12b, the devices may communicate with one another, for example, by using Bluetooth™, WiFi, Li-Fi, 4G or 5G, near field communication, or other local wireless communication protocols. Wearable devices 12 may alternatively also communicate with one another via server 100.

System 10 may determine that two or more wearable devices 12 are in close proximity to one another by wearable devices 12 directly detecting signals from other wearable devices 12. Alternatively, server 100 may receive location information from wearable devices 12 (the location information may, for example, comprise coordinates from a GPS system, coordinates determined from a cellular or other data connection to the wearable device 12, and/or coordinates determined from analysis of signals such as WiFi signals detected by the wearable device 12) and may determine when different wearable devices 12 are in proximity to one another by comparing the location information.

When wearable device 12a and wearable device 12b are determined to be in close proximity to each other and both have their verified status set, wearable devices 12a and 12b may exchange information about their authorized users. This information may be provided audibly and may, for example, comprise the real name of each authorized user. In an example embodiment, the basic information exchanged between wearable devices 12 preferably includes each authorized user's name together with his or her birth place. Some information, such as the authorized user's birth date, may be kept private and not exchanged (unless the authorized user specifically allows such information to be shared). Wearable devices 12a and 12b may keep a record of where and when their authorized users met.

Wearable devices 12 may also optionally exchange additional information beyond basic information (in some embodiments, the type of information exchanged may be set by the authorized users of wearable devices 12 and/or by an administrator of the wearable devices 12). Such information may include one or more of the following information about an authorized user:
profession, employer, job title, organizational division, business address, or age;
interests, education or qualifications, or current certifications (e. g. first aid, driver's license, trade certification, etc.);
contact information (such as one or more of telephone number, email address, social media contact information, etc.);
medical information (e. g. allergies, medical conditions, medications, blood type, etc.);
citizenship, country of origin, or country of residence;
document information (e. g. driver's license number, passport number, professional association membership number, etc.) residence address; and/or
public encryption key, a picture of the authorized wearer, or marital status.

In one embodiment, some or all of the above information is only exchanged after the authorized user provides permission to do so (e. g. by moving such information out of a “private” section of the authorized user's account to a “restricted” section). For trusted relationships, the wearable device 12 may replace the user's identification (e. g. social insurance number, credit cards, passports, etc.).

In some embodiments, the selection of information to be exchanged regarding a first authorized user of a first wearable device 12 depends on the role of a second authorized user of a second wearable device 12. For example, the system 10 may be configured to provide a different set of information in the first authorized wearer's “restricted” section, depending on whether the second authorized wearer is:
a police officer; a customs or immigration officer; a fellow employee of the first authorized wearer; a member of the opposite sex; an emergency responder; a neighbor; and/or
a fellow citizen of the same country.

The information exchanged may be any of a wide variety of types. This information may even include sensitive and personal information under the authorized user's “private” section (if so permitted by the authorized user). The date, time, contents, recipient, and even the circumstances of each information exchange can be recorded in database 104 to allow for tracing in the event of any abuse. This, along with biometric verification, helps to ensure that the authorized user can be satisfied that:
information that he or she receives from server 100 about another authorized user is accurate;
the person that the authorized user is interacting with is the other authorized user and not somebody else pretending to be that other authorized user; and/or
his or her own sensitive information will be provided only to people who should receive that sensitive information.

Particular aspects of the invention provide a registration process for registering the wearable device 12. It is desirable to associate the wearable device 12 with a specific individual. Where the wearable device 12 is reliably associated with a specific individual, then the wearable device 12 may form part of a trusted network. This opens a wide range of possibilities for the wearable device 12 to be used to facilitate transactions and interpersonal arrangements.

One way to associate a particular wearable device 12 with an individual is to have a person (e. g. a government official) verify the identity of the individual in person by checking identification documents and then taking steps to link the identified individual to a specific wearable device 12. This is possible but undesirably bureaucratic and labor-intensive.

Instead, a self-service automated wireless registration process may collect linking information from and to a specific wearable device 12 interlocked with unique numbers explained later below, collect known verification information about the specific individual, and collect the linking and verification information in a way that ensures the accurate identification and registration of the specific individual.

This may be done by one or both of collecting the information and linking the verification information simultaneously and providing a mechanism that monitors to make sure that the linking information and the verification information cannot correspond to different individuals.

In an example embodiment, the verification information may comprise a photograph of the specific individual that can be compared to photographs of the same individual in an officially-trusted database (e. g. a database maintained by a government entity that issues official identification such as passports, identity cards, drivers' licenses, or the like). Verification information could also, or in the alternative, include biometric information if biometric information is also stored in the officially-trusted database. The use of other corroborating verification information (such as information that would be known to the specific individual, but would not be readily known to others) may optionally form part of the verification information.

Linking information includes the combination of information that (1) identifies a specific wearable device 12 and (2) identifies the specific individual. For example, the linking information identifying the specific wearable device 12 may comprise an unchangeable serial number (or a combination of several serial numbers) built into the wearable device 12. The linking information identifying the specific individual may comprise biometric information collected by sensors of the wearable device 12.

The registration process comprises linking a specific person Pa, Pb, Pc to a corresponding wearable device 12a, 12b, 12c, respectively. The wearable device 12 may be configured to require such a registration process to be performed before certain features of wearable device 12 are enabled. For example, registration may be required before an authorized user can use any features provided by wearable device 12, such as accessing the cameras 26, microphone 24, or GPS component 36 (as shown in FIGS. 2 and 3). Alternatively, registration may be required before a user can use advanced features of the wearable device 12, such as accessing a bank account or an electronic wallet or accessing a service requiring authentication.

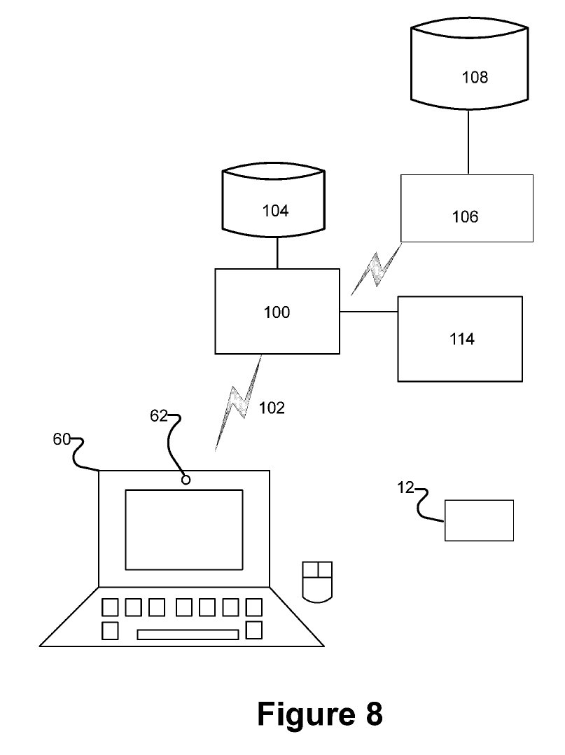

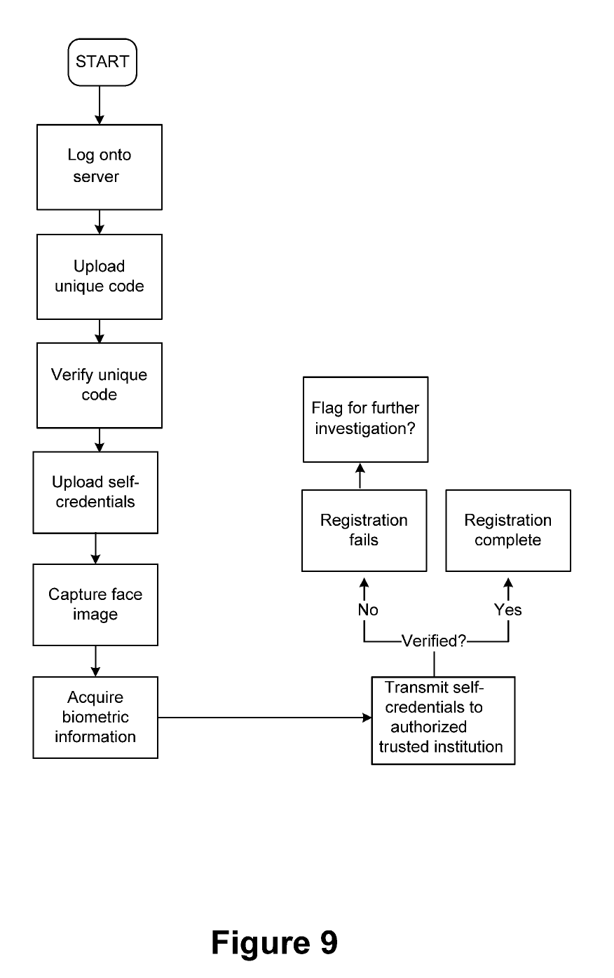

FIGS. 8 and 9 depict examples of the registration process. The user initiates the registration process (e. g. by visiting a website or activating an application that runs on the wearable device 12 or on another network connected device). After the registration process has been initiated, the user puts on the wearable device 12 if the user is not already wearing the wearable device 12. The wearable device 12 then operates one or more of the sensors 32 to acquire biometric information about the user. A monitoring device 60, which may be separate from the wearable device 12, may operate to obtain a photograph of the user. In one embodiment, the photograph may be obtained substantially simultaneously with the biometric information. In some embodiments, the registration process ensures that the wearable device 12 is worn continuously by the same individual between obtaining the verification information and obtaining the biometric information.

In some embodiments, the verification information includes information that also identifies the specific wearable device 12. This may be achieved, for example, by causing the wearable device 12 to emit unique signals (e. g. flashing light patterns) that are detected by the monitoring device 60.

FIG. 8 is an illustration of an example of the registration process. In this example, the monitoring device 60 comprises a separate computing device. The monitoring device 60 may be separate from, but wirelessly linked to, the wearable device 12. Monitoring device 60 comprises at least one image capture device 62 (e. g. a built-in or attached camera) and is able to communicate with server 100.

As described above, the server 100 is connected to the database 104. The server 100 is also connected to one or more authorized trusted institutions 106, which may maintain separate authorized trusted databases 108. Alternatively, the database 104 may already include data from the authorized trusted databases 108. The authorized trusted institutions 106 may include, for example, government agencies.

FIG. 9 is a flowchart showing an example of the registration process. In this example, the user begins registration by logging onto the server 100, such as through monitoring device 60. Next, the user enters and uploads at least one unique code associated with wearable device 12 to the server 100. The unique code may, for example, comprise a serial number of wearable device 12. In some embodiments, the unique code may be read directly from wearable device 12 by connecting wearable device 12 to the monitoring device 60. In some embodiments, initiation of the registration process may be triggered from wearable device 12 itself by executing an application to initiate the registration process. In other embodiments, the user may enter the unique code using a keyboard, by scanning a symbol or pattern that incorporates the unique code, or the like. The unique code for each wearable device 12 may have been previously uploaded to database 104 by authorized manufacturers of the wearable device 12.

The server 100 receives the unique code entered by the user. The server 100 accesses database 104 and attempts to match the user-inputted unique code with the collection of unique codes stored within database 104 by the authorized manufacturers. The result of this step may be used to verify the authenticity of the wearable device 12 against counterfeit products. If the user-inputted unique code is not found in the collection of unique codes stored in database 104, this may be an indication that the wearable device 12 is a counterfeit product or that the user has made a mistake in entering the unique code. The registration process can either not continue, if the verification step fails or it may still continue, with the server 100 marking the user for further investigation.

If the server 100 determines that the unique code corresponds to the wearable device 12 that has already been registered to a person, then the verification step may also fail. In this case, server 100 may request the user seek further assistance.

Otherwise, the user next provides information about himself or herself, which may include, for example, one or more of name, address, birth date, birth place, driver's license number, passport number, social insurance number, telephone numbers, employer(s), and/or credit card numbers. Such personal information may be uploaded to server 100 and may be used to create an account for the user to be stored in database 104. The information may be stored within the “private” section of the user's account. This prevents others from accessing this information; however, the server 100 may use the information for automatic verification purposes.

The user is next instructed to put on the wearable device 12 and to look towards image capture device 62. The monitoring device 60 may display a message prompting the user to look towards the image capture device 62 that captures at least one facial image of the user wearing the wearable device 12. The facial image(s) may then be transmitted to server 100 from monitoring device 60 and stored in database 104. Server 100 may subsequently transmit the facial image(s) to the authorized trusted institutions 106 for verification.

Biometric information for the user is acquired using the one or more sensors 32 of wearable device 12. The biometric information may be stored locally on wearable device 12 and/or uploaded to server 100 and stored in database 104. Server 100 may also transmit the biometric information to the authorized trusted institutions 106 for verification.

Wearable device 12 may comprise sensors 32 for detecting motion (e. g. sensors 32b). The motion sensors 32b detect any movement of the wearable device 12 once the user puts on wearable device 12. An output of the motion sensors 32b may be communicated to server 100 and/or processed by the processor 22, which may also verify or, in the alternative, monitor other sensors 32 to ensure that the wearable device 12 is worn continuously. The other sensors 32 may comprise some or all of the same sensors 32 used to acquire the biometric information.

Server 100 may be notified if the motion sensors 32b sense movement of wearable device 12 during the registration process that could indicate that the user removed wearable device 12 at some point between capturing a facial image of the user wearing the wearable device 12 and acquiring biometric information from the user. This check ensures that the user does not remove wearable device 12 during the entire period between the capturing of the facial image(s) and the acquiring of biometric information. If server 100 is notified that the user has moved or removed wearable device 12 during the registration process, this may cause the registration process to fail or to require a restart.

To further prevent falsification, a second check may be provided. In some embodiments, wearable device 12 may display a code when capturing the facial image(s). The code may, for example, comprise a randomized combination of colors, numbers, or a flashing light pattern uniquely generated at server 100 for the registration of each wearable device 12. Server 100 transmits the code to wearable device 12 to be displayed. The code may be displayed on the display screen(s) 58. The code may also be displayed on any other suitable location on wearable device 12 that is visible to image capture device 62 when a facial image is being captured. The transmission may occur upon receiving a signal from monitoring device 60.

The transmission and display of the code at wearable device 12 may be performed before (and/or during or immediately after) capturing of the facial image and biometric information. The displayed code can thus be captured along with the facial image. Upon receipt of the facial image, server 100 compares the displayed code captured in the facial image to verify that the code captured and visible in the facial image is the correct code that was generated for the registration of the particular wearable device 12.

One purpose of the above checks is to prevent two or more people from attempting to “game” system 10 (e. g. by providing verification information of two different persons). Such additional checks attempt to prevent situations where user Pa uploads his/her personal information and facial images onto server 100, but user Pb (who is not in the field of view of the image capture device 62) puts on wearable device 12 during the biometric information acquisition step. In such a case, the biometric information that is stored in memory in wearable device 12 would not correspond to the biometric information of user Pa, and user Pb (using a fake identity) may falsely be allowed access to wearable device 12 using the identity of user Pa.

If such a situation was detected, the wearable device 12 may be flagged as being suspicious within system 10 (as further discussed below) and its activities monitored.

Next, the server 100 transmits the user's information (as inputted by user), facial image(s), and biometric information to one or more authorized trusted institutions 106 for verification. This is to check the user's self-recorded information, facial image(s), and biometric information against information contained in the authorized trusted databases 108 maintained by the authorized trusted institutions 106. Such authorized trusted databases 108 may include police databases or passport databases.

In some embodiments, a facial recognition engine may be built into server 100. In such embodiments, one or more authorized trusted institutions 106 transmit to server 100 one or more facial image(s) of the particular user, upon request by server 100. The facial recognition engine maps the facial image captured earlier with the certified facial image(s) sent by the authorized trusted institution 106 to verify the user's identity. In other embodiments, a facial recognition engine may be built into the server of the authorized trusted institution 106. In such embodiments, the mapping of the captured facial image with the certified facial image(s) stored in the authorized trusted databases 108 is performed at the server of the authorized trusted institution 106. The verification results are subsequently transmitted from the server of the authorized trusted institution 106 to the server 100.

In some cases, rather than transmitting an image to or from the authorized trusted institution 106, a “fingerprint” or other characteristic that reasonably uniquely identifies the image may be transmitted instead. The fingerprint may be compared to a fingerprint calculated from the facial image(s) to determine whether or not the facial image(s) acquired by the monitoring device 60 matches one or more images of the user in the records of the authorized trusted institution 106.

In addition to the authentication of the facial image(s), the user's self-recorded credentials and/or biometric information may also be transmitted by the server 100 to the server(s) of the authorized trusted institution 106 for identity verification. The server(s) of the authorized trusted institution 106 compare the information contained in their authorized trusted databases 108 with the credentials and/or biometric information transmitted by server 100 to verify the user's identity.

The registration process is complete (and thus the user is authenticated) if all of the information received in monitoring device 60 match the certified information that are stored in authorized trusted institution 106. The personal and biometric information of the user are thus associated with the particular wearable device 12. Such information is stored in database 104 and may also be stored in the authorized trusted databases 108 of the authorized trusted institutions 106.

If any of user's self-recorded credentials, biometric information, and/or facial image(s) do not match the information maintained by the authorized trusted institution 106, or if the user's self-recorded credentials already exist in the database 104 (e. g. a user is attempting to register the wearable device 12 that has already been registered), various actions are possible. In one example, the certified facial image(s) maintained by the authorized trusted institution 106 may be significantly different from that of the facial image taken by the image capture device 62. The two facial images may depict the same person but are captured at different periods of time such that his/her facial features have changed. In such circumstances, the user may be notified by server 100 at the monitoring device 60 to update his/her photograph with some designated institution (e. g. at the passport office). The user may be blocked from accessing and operating the wearable device 12 until a new facial image has been updated with the authorized trusted institution 106.

In another example, the wearable device 12 may be made operational as if it were properly registered, but the wearable device 12 may be flagged to indicate that the user's identity is suspicious. System 10 may be configured to flag the wearable device 12 as suspicious if the user attempts to register himself or herself using fabricated information. For example, the server 100 may be programmed to allow the user three chances to upload to server 100 his or her real self-recorded credentials/facial image during the registration process. If the user fails to do so, the wearable device 12 that the user is attempting to register will be flagged as suspicious. In some embodiments, appropriate authorities are automatically notified when the wearable device 12 is flagged. In such cases, the appropriate authorities can track such wearable device 12. In particular embodiments, system 10 may allow such user an opportunity to remove the suspicious flag, for example, by transmitting a notice to the display screen(s) 58 of the wearable device 12 indicating that the user's identity appears suspicious. The user may then attend to the nearest government authority (e. g. the police department) to perform an identity check. Appropriate authorities may be authorized to access server 100 to remove the suspicious flag associated with the particular wearable device 12 upon clearance.

The unique code (which can be a serial number of the wearable device 12) is used to identify a particular wearable device 12 and to associate the particular wearable device 12 with one user in the registration process. The unique code may be stored in database 104 in conjunction with a plurality of unique identification numbers which also identifies each wearable device 12. Each unique code corresponds with a set of unique identification numbers. Upon successful association of each unique code with a particular user in the registration process, the set of unique identification numbers is also linked to the user. Each set of unique identification numbers is thus linked to the biometrics of each user upon registration of wearable device 12. In particular embodiments, the unique code is only used in the registration process. Such unique code may or may not be permanently removed from database 104 after the registration process is complete. The set of unique identification numbers may thus be used as an identifier within server 100 and the database 104 or server(s) of authorized trusted institutions 106 to identify the registered user of each wearable device 12 post registration of the device. The identification within this set of unique codes may utilize various algorithms to prevent the locked-in wearable device from being hacked, stolen, or abused by persons not supposed to wear it.

The plurality of unique identification numbers may comprise hardware identification information. Such information includes information that is not routinely transmitted over networks, exposed to the Internet, or incorporated within an Internet Protocol (IP) address, such as a Media Access Control (MAC) address or the like. Hardware identification information comprise identifiers that are electronically recordable and may be fixed or etched in on one or more hardware components that are built into wearable device 12 by authorized manufacturers. In other words, hardware identification information comprises static identifiers of each wearable device 12. Non-limiting examples of hardware identification information include, but are not limited to, central processing unit (CPU) serial numbers, printed circuit board (PCB) serial numbers, and international mobile equipment identity (IMEI) numbers.

The set of hardware identification information and the corresponding user information (e. g. biometric information, personal information, and facial image) of each registered wearable device 12 may be stored in database 104 and by authorized trusted institutions 106 for verification purposes.

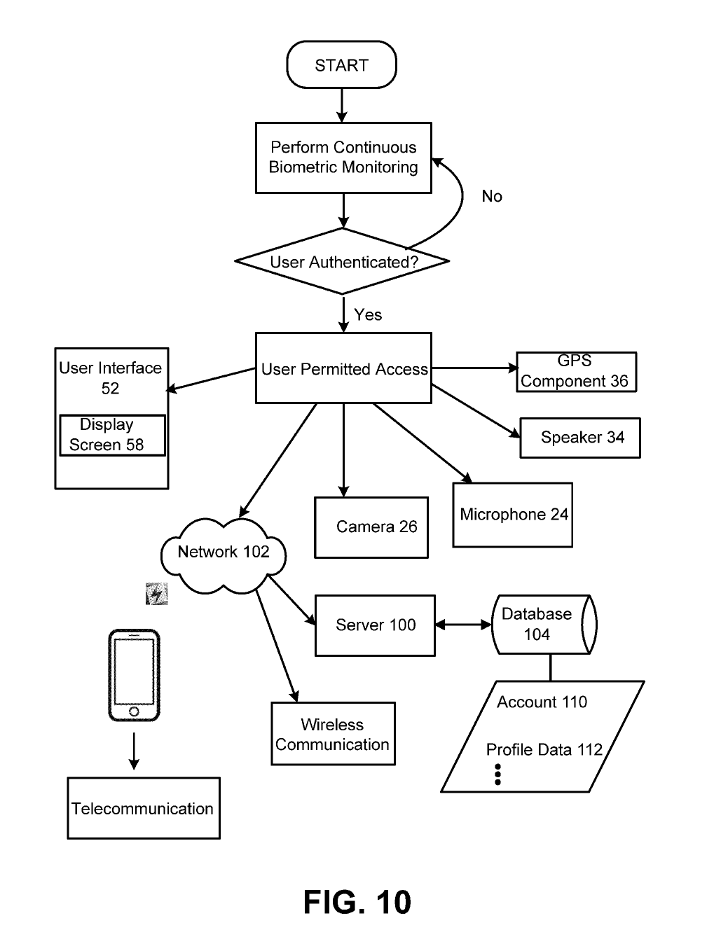

Once a user completes registration, a user account 110 (see FIG. 10) is set up in the database 104 for each registered user and the linked wearable device(s) 12. The user account may comprise profile data 112 for the user.

In another embodiment, each registered wearable device 12 is adapted to communicate with other institutions at any time. Each communication comprises the transmittal of information from the wearable device 12 through the server 100 to the server(s) of the other institutions. Each communication begins with a user authentication process. The authentication process is performed so that the other institutions can confirm the identity of the wearable device 12 prior to the transmittal of data. Such data may include completing a transaction if the other institution is a bank or making an emergency call if the other institution is a police department. This allows the other institution to reliably identify the real identity of the user without requiring the user to self-identify (e. g. such as by using a password, which could waste valuable time during an emergency).

In particular embodiments, to protect system 10 from being attacked by unauthorized users (e. g. to prevent hackers from intercepting information from the wearable device 12 to the server(s) of the authorized trusted institution 106 during the authentication process), one or more dynamic identifiers of each wearable device 12 are generated. The server 28 may generate one or more dynamic identifiers. The dynamic identifiers may be generated (using appropriate algorithms) using data based on some or all of the hardware identification information. The dynamic identifiers may be programmed to automatically update or change within a predetermined time period. In some embodiments, the dynamic identifiers may be updated prior to or during each authentication process. The one or more dynamic identifiers are neither printed on wearable device 12 in a form that is visible to users nor stored locally in memory 40 within wearable device 12 in a manner which is locatable and searchable by users. The dynamic identifiers are not disclosed to the user and may not necessarily be in a fixed format.

In case of a lost wearable device 12 or a wearable device 12 that is not used for a preset period of time, the wearable device 12 may cease to function. In case of a defect in the wearable device 12, the wearable device may suspend verification of this particular wearable device 12. The user can then switch the verification to another wearable device 12 associated to the same registered user. Only the activated wearable device 12 currently worn by the user functions and verifies well, while other (currently unworn) wearable devices 12 may dim to black and be deactivated within the system 10.

During the authentication process, the dynamic identifiers may be sent from server 100 to the server(s) of the authorized trusted institution 106. The server(s) of the authorized trusted institution 106 are adapted to decrypt the dynamic identifiers to reproduce the original set of hardware identification information. The server(s) of the authorized trusted institution 106 then matches the set of hardware identification information decrypted from the dynamic identifiers with the set of hardware identification information that is originally stored in memory in its database(s). The identity of the registered user is authenticated if the two sets of hardware identification information match. Upon successful authentication, the registered user may continue to transmit data to or communicate with the server(s) of authorized trusted institutions 106 using wearable device 12. The user may be blocked from transmitting data to or communicating with the server(s) of authorized trusted institutions 106 using wearable device 12 if authentication fails (i. e. if the decrypted set of hardware identification information is not the same as the set that is originally stored in its database).

Any multiplicity of algorithms may be applied for encrypting and decrypting the plurality of hardware identification information. The algorithms may comprise arithmetic operations such as additions, subtractions, multiplications, dividing, square root operations, trigonometric functions, quadratic functions, combinations of these, more complex functions and the like. In some embodiments encryption is performed using public key encryption algorithms. A person skilled in the art would appreciate that many different combinations of arithmetic operations are possible to generate the dynamic identifiers using the plurality of hardware identification numbers. One exemplary algorithm may comprise the following operations: subtracting hardware identification number A (e. g. A being the serial number etched on a CPU) from hardware identification number B (e. g. B being the serial number etched on a PCB) and adding to hardware identification C (e. g. C being the IMEI number). Another exemplary algorithm may comprise the following operations: taking the square root of hardware identification number A (e. g. A being the serial number etched on a CPU) and adding to hardware identification number B (e. g. B being the serial number etched on a PCB) and then dividing the result by hardware identification C (e. g. C being the IMEI number). In some embodiments, different algorithms may be applied for different groups of end users at a given time, such as by gender, age, marital status, postal codes, certain biometric characteristics or even the time of day. For example, a particular algorithm may be used for all female end users, and another algorithm may be used for all male end users at a given time. It may switch or update from time to time (either on regular or irregular intervals). The purpose of this irregular complexity is to prevent hackers from hacking into the system 10.

FIG. 10 illustrates a method for authenticating a user in order to determine whether the user can access a registered wearable device 12 according to an example embodiment of the invention. The user first secures the wearable device 12 to the user's body. Once the wearable computing device 12 is properly secured to the user's body, the sensors 32 mounted on the wearable device 12 may begin collecting biometric data from the user. The biometric data is then processed by the wearable device 12 to authenticate the user's identification. If the collected biometric data matches the registered user's reference biometric data that is stored in the memory 40 of the wearable device 12 and/or retrieved from database 104, the user's identity is authenticated, and the wearable device 12 is switched to have a verified status. Once the registered wearable device 12 has a verified status, the user is allowed to access the wearable device 12, e. g. to use one or more of the cameras 26, microphone 24, GPS component 36, user interface 52, and/or accessing wireless network 102.

Accessing the wireless network 102 permits the user to link the registered wearable device 12 to one or more of the user's additional computing devices, such as phones, tablets, laptops, doors (home or vehicle) and/or the like. Passwords and/or encryption credentials for accessing the additional computing device(s) may be stored in wearable device 12 or uploaded to his/her own online account in an encrypted format and made available when wearable device 12 is in its verified state. After wearable device 12 has established communications with additional computing device(s), the user may control and operate the additional computing device(s) remotely by issuing commands into the registered wearable device 12. For example, the user may make a voice telephone call from a connected phone (not shown) by issuing voice commands into the microphone 24 of wearable device 12. Alternatively or additionally, a user may control a graphical user interface on one or more additional computing devices(s) with gestures captured by wearable device 12. Furthermore, wearable device 12 may also control other items like drones, vehicles, robots, vacuum cleaners, doors, appliances, etc., as long as these items are linked with the wearable device 12.

Accessing the wireless network 102 also allows the user to access his or her user account 110 in database 104 via server 100. The user may modify certain aspects to the profile data 112 in his or her user account 110. Changes to some items of profile data 112 may require verification so that the information about the registered user in database 104 can always be trusted.

Profile data 112 comprise content that is uploaded by the user from wearable device 12 or other computer devices to database 104. Examples of such content include images and videos taken by cameras 26 that are built into wearable device 12, recordings of telephone conversations between the registered user and others, and textual material created by the user.

A user may also view at least certain information from profile data 112 of other users. Registered users may choose to share certain information with all or some selected other registered users. For example, information in the “public” section can be viewed by any user. Information in “restricted” section can only be viewed by preselected users, e. g. close relatives, friends, emergency personnel (in case of emergencies). Information in the “private” section can only be viewed, modified, or deleted by the registered user himself or herself. Information in a “commercial” section may or may not be viewed by other users, depending on the preference of the user. For example, a user may wish to display to others that he or she purchased a particular item. This information could appear in the “commercial” section of the user. If the user does not wish the information to be displayed, it will remain hidden; however, statistical information may still be retained. Since each registered user is biometrically verified, unauthorized users cannot access information in database 104 by guessing passwords. This prevents any hacker from entering unwanted sections of the registered users.

The server 100 may also be connected to a web server 114 for hosting a social media platform that allows users to share data with one another, either via his or her “restricted”, “public”, or “commercial” sections. Registered users may select the particular information to share or keep confidential. Some data may also be considered as “emergency data” in the “restricted” section and would be transmitted directly to a predetermined emergency response provider so that it does not need to worry about the authenticity of the registered user's identity. In emergency situations, calling for help may be done by voice or eyeball tracking.

Profile data 112 may comprise private, restricted, public, and commercial data. Users may mark individual profile sections as one of private, public, restricted and commercial data. Private data may comprise items the user does not wish to share with anyone. Restricted data may comprise items that users wish to share with a government or trusted agency such as the police department, close relatives, friends, employer/employees, or colleagues. Restricted profile data may be automatically and instantaneously transmitted to an authorized institution. In particular embodiments, such authorized institutions are alerted or notified as soon as new restricted profile data are received. Public data may comprise items the user wishes to share and are thus accessible to all registered users. Commercial data may comprise data regarding shopping behavior that the registered user may or may not want to share with others.

In some embodiments, wearable device 12 may be programmed to automatically upload certain items/activities from wearable device 12 to server 100. Server 100 may store the uploaded items/activities in database 104 as restricted profile data. Such items may include activities requiring emergency assistance, such as any text or voice input into wearable device 12 from the user containing preselected words indicating an emergency situation. Words such as “help”, “rescue”, “911”, and/or “police” may be interpreted as commands to turn on the cameras 26 of wearable device 12 and begin videotaping and uploading to the server 100 instantly. Similarly, the sensors 32 (such as sensors 26b for tracking eye movements) on wearable device 12 may be programmed to detect an emergency command to turn on the cameras 26 by tracking particular movements of the eyeballs. The video is then automatically uploaded and stored in database 104 without the need for voice input from the user.

The user may also self-pre-program emergency commands that are unique to his or her wearable device 12 (e. g. a user may program into his or her wearable device 12 the phrase “how is the weather” or “how lovely you are” or “come and talk for a while” as an emergency activation command). Such types of emergency commands may be used so that any assailants will not be alerted, but the relevant emergency institutions can be notified. In such examples, any text or voice input of the phrase “how is the weather” or “how lovely you are” or “come and talk for a while” into the wearable device 12 would be an indication of an emergency. As a result, the videotaping function will be turned on immediately for uploading. The recorded video file may be simultaneously uploaded to server 100 and placed in the user's “restricted” section. Such data may also be automatically transmitted to the appropriate emergency institutions (e. g. a police department). This is especially useful in emergencies where the user may not be able to easily make an emergency call or even speak. The emergency institution may be the same or different from the authorized trusted institution 106 used in the registration process.

In some embodiments, wearable device 12 comprises one or more emergency buttons 64 shown in FIG. 2. The one or more emergency buttons 64 may be positioned on the lens elements 18 and/or the arms 14. In particular embodiments, the emergency signal may also be activated via sensors 32 for tracking eye movements. Upon activating one of the emergency buttons 64, videotaping commences immediately and begins uploading to server 100 to the user's “restricted” section.

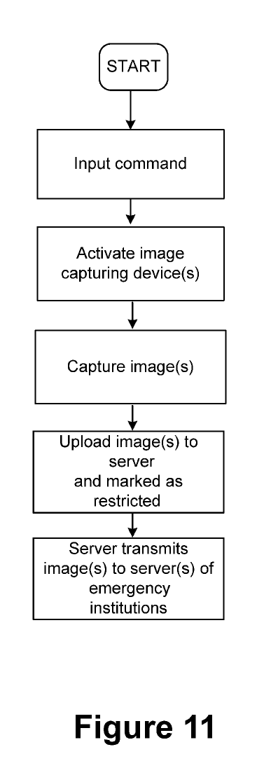

FIG. 11 is a flow chart illustrating an example application of a method for activating an emergency command on wearable device 12. A user activates a pre-programmed emergency command on his or her wearable device 12. The emergency command can be in the form of a text, a voice command, a touch command, or silent eyeball tracking command. Next, the wearable device 12 activates the cameras 26 upon receipt of the emergency command. The cameras 26 capture at least one image and/or video of the surroundings and upload it (through the transceiver 30) to the server 100. Depending on the cameras 26, the captured image(s) and/or video(s) may be even beyond the user's field of sight.

The at least one image and/or video uploaded to server 100 is automatically placed in the user's “restricted” section without requiring the user's further categorization of the data. The at least one image and/or video is then transmitted to the appropriate emergency institution, such as the police department. Each image comprises information that is stored as metadata associated with each image and/or video identifying the specific person who acquired the images as well as the date, time, and geographical location of creation of the image and/or video (discussed in further details below). Emergency institutions receiving the one or more images and/or video are able to act accordingly without requiring further input from the user.

System 10 may automatically embed watermarking or other information into the data for images, videos, or audio taken by the wearable device 12 and link them to corresponding authorized user. The information may include one or more of WHO has done WHAT, in WHICH angles in relation to the north or south, WHEN and WHERE:
information identifying the registered user who took the images, videos, or audio;
information identifying whose wearable device 12 taking the images, videos, or audio;
the time and date when the images, videos, or audio were taken (this information may, for example, be obtained using a GPS adjusted real-time clock of wearable device 12);
the location (and elevation) at which the images, videos, or audio were acquired (such as coordinates, country, city, nearby landmarks, etc.); and/or
information about what is depicted in the images, videos, or audio.

One example of a verifiable linkage for an image taken by the wearable device 12 may be the following:

“www.mefon.ca/ca.wang.shan.kunming.cn/275.68/seen-obama-in-NY.us/1611301530 48/A-95.68/N-48.376/W-30.2514”. This indicates that the database 104 is located in Canada and other information regarding the image (e. g. latitude of 48.376° N, longitude of 30.2514° W, elevation of 95.68 meters, angled at 275.68° to the north, time and date of Nov. 30, 2016 at 15:30:48, etc.). Even if the same registered user goes back to the same location (48.376° N, 30.2514° W), the same elevation (95.68 meters), and the same angle (275.68° to the north), the time will be different. This means that the information for every image or video taken by the wearable device 12 is unique and cannot be duplicated. This allows for subsequent searching to be more efficient as different criterion can be searched independently (in either ascending or descending order).

Such information may be stored as metadata in each image, video and/or audio file. Metadata may also, or in the alternative, be stored in each media file (image and/or video and/or audio) in the form of a digital watermark (that may be visible or invisible to the human eyes). All photos, videos, or audio uploaded onto database 104 may thus carry metadata identifying the specific person acquiring the images, videos, or audio as well as the date, time and geographical location for creating the images/videos/audio. This information may be assigned with a digital certificate of the authorized user of the device 12 so that the media's authenticity (video and/or still image and/or audio) can be established. Wearable device 12 may be configured such that the digital signing function is available only when the user wearing the wearable device 12 has been verified biometrically because he or she is the authorized user of the wearable device 12.

Wearable device 12 may be configured such that the digital certificate is available not only for use by the wearable device 12, but also can be copied or otherwise extracted from the wearable device 12 in any practical way as long as the authenticity is traceable. In some embodiments, the digital certificate is stored in a part of memory 44 of wearable device 12 that is accessible only to a dedicated circuit configured to apply the digital certificate to digitally signed files such as media files. In some embodiments, the separate memory and dedicated circuit are both provided in an application specific integrated circuit (ASIC). In some embodiments, the dedicated circuit comprises a part into which biometric information for the registered user of the wearable device 12 is permanently written together with circuits that function to receive and biometrically verify the identity of a user using the biometric information.

In some embodiments, each time an image or other media is acquired, wearable device 12 performs a biometric check of the identity of the user of the wearable device 12 at substantially the same time that the image or other media is acquired. This guarantees that the identity of the person taking the image (or other media) can be accurately determined.

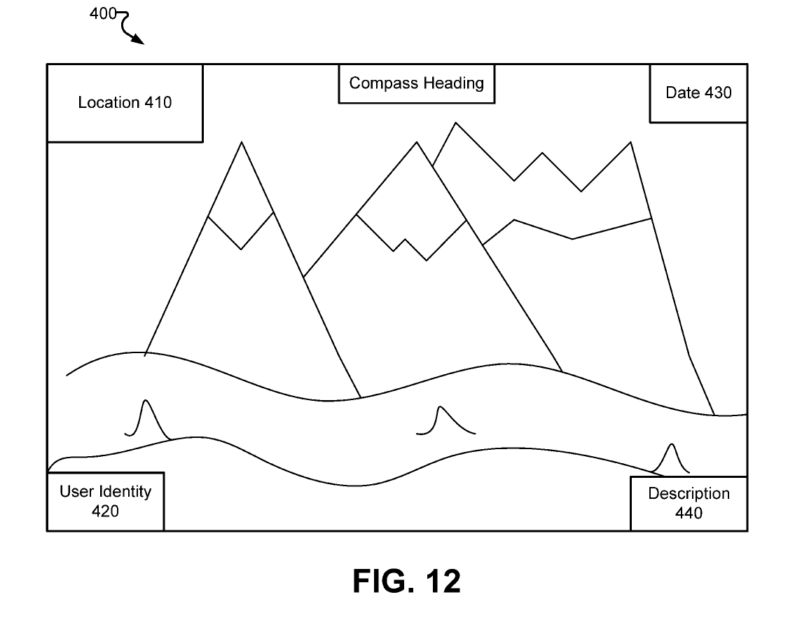

In some embodiments, information is embedded into the image or video itself and would be visible when viewing the image or video as shown, for example, in FIG. 12. FIG. 12 depicts an image 400 having location 410, user identity 420, date and time 430, and image description 440 embedded in the image 400. This information may, for example, be displayed in the corners or at the edges of image 400. The compass direction in which the image 400 is taken may be also displayed in the image 400, for example, in the top or bottom or side edges of the image 400. In other embodiments, information may be embedded in other locations on image 400. Furthermore, the information may be in any one of multiple languages (e. g. English, Chinese, etc.). For some languages, the information may be displayed vertically (instead of horizontally). In addition to displaying the information, the information may also be linked to one or more designated databases so that the source can be verified even if these 4c5d data (which means “5 data at 4 corners or edges”) is cut off or truncated.

Any or all of this information may also be stored as searchable and computer readable metadata associated with the image 400. Preferably, high-precision location and directional information is included as metadata linked to the image 400. Another piece of information that may be associated with image 400 is the field of view, which may vary in the case of a camera with zoom functionality. The field of view may be used together with the directional information to locate images that could possibly show an event occurring at a specific location or even the same location with different angles or different heights.

In some embodiments, the information is displayed against a background that contrasts in color/tone with the surrounding parts of the image 400. Color and/or tone of the text in which the information is presented may also be automatically selected to contrast with the background. For example, image processing may be performed to determine representative colors and tones of corner regions of the image 400 where information will be displayed. An inverse or contrasting color and/or tone may then be automatically selected for the background. An area of the image 400 where the text will be displayed may then be set to the selected inverse and/or contrasting color and/or tone. At the same time, a color and/or tone for the text displayed may be automatically selected. This process may be performed separately for each edge or corner of the image 400 in which information will be displayed.

In some embodiments, the image data is altered such that the text containing information and its contrasting background area becomes part of the image 400 itself. In other embodiments, data for the original image 400 is preserved and the text containing information and its contrasting background area may be superposed on the displayed image 400. In either embodiment, the information associated with the image 400 (such as where the image 400 was taken, when the image 400 was taken, in which angles with respect to north and south, and by whom was the image 400 taken) may be associated with the image data in a digitally signed package such that neither the image data nor the associated information can be altered without detection.

If the metadata (like WHO did WHAT in which ANGLE to the North or South at WHEN and WHERE in which HEIGHT, etc.) is displayed on the image 400, the metadata should be in a format that is understandable. For example, compass direction may be indicated in terms of the compass points (e. g. N, NW, S, SW, etc.) or in terms of a compass heading (e. g. 322 degrees, 113 degrees) or both. The directional information may be referenced to magnetic north, grid north, true north, etc. Where the wearable device 12 comprises cameras 26 that are oriented to take pictures in different directions (e. g. front-facing cameras and rear-facing cameras) images taken by each camera 26 may be associated with a different compass direction. The specific locations at which individual data is displayed in images or videos may vary.

In some embodiments, the watermarks may be in the form of individual small packets (or pixel dots) each associated with an ASCII digit or code revealing part of the metadata respectively even if the image has been cropped. A plurality of packets may be distributed throughout the entire image or video. The plurality of packets may or may not necessarily be distributed in accordance with a predefined pattern within an image. Such predefined patterns may be randomized. The particular pattern may not be known to the user. The small packets (or pixel dots) as well as the information embedded within each of them may not be visible to human eyes. The information may be discernable when the packets are magnified. In particular embodiments, only authorized government agencies have access to the suitable magnifiers that are capable of discerning the watermarking information for verifying the authenticity of particular images or videos taken by the wearable device 12.

In some embodiments, each packet comprises information identifying the metadata relating to specific person who acquired the images or videos, what is depicted in the file, as well as the date, time, and geographical location of the images' or videos' creation. In such embodiments, each of the small packets comprises the metadata describing at least any of these 4c5d factors, but limited to WHO has done WHAT, in which DIRECTION to the North or South at which HEIGHT, WHEN and WHERE (4c5d).

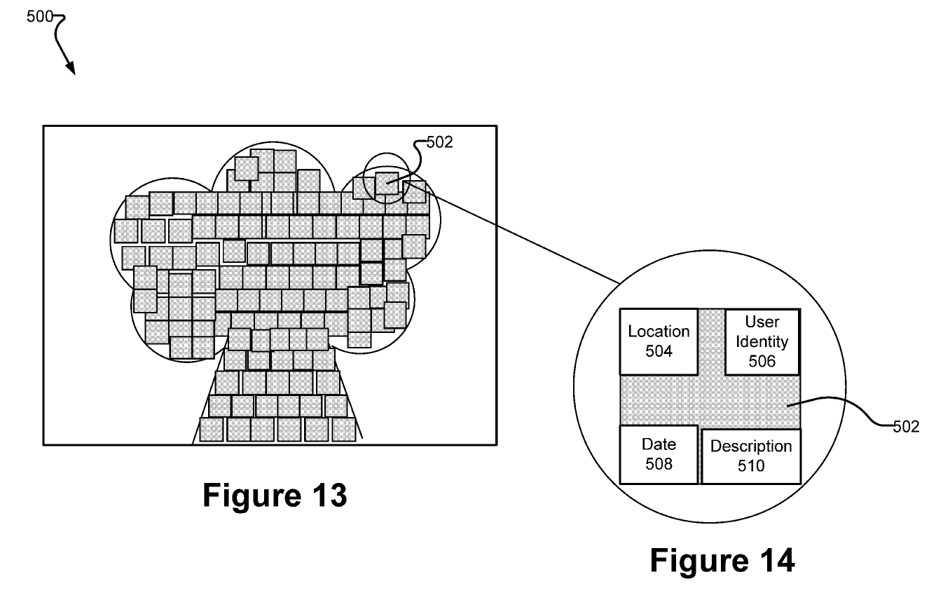

FIG. 13 depicts an image 500 incorporating a digital watermark according to an example embodiment. Image 500 is a photograph captured by wearable device 12, comprising a plurality of small packets 502 distributed throughout a predefined region or pattern visible or invisible to the human eyes. In the embodiment, the small packets 502 are distributed within image 500 in an orderly manner, although it is understood that it may also be arranged in a disordered manner. Small packets 502 may also be distributed within image 500 in a random manner. FIG. 14 is an enlarged depiction of each packet 502. Each packet 502 may comprise location 504, user identity 506, date 508 and image description 510 embedded in the image 500. In some embodiments, each packet comprises a generally square configuration, and each item of information within each packet is positioned at a corner or edge of the square, although this is not mandatory. Each packet may comprise any suitable configuration of any kind or pattern normally not visible to human eyes. The information within each packet may be embedded within the image at any suitable location.

In some embodiments, each of the small packets embedded within an image or video comprises different metadata. In such embodiments, each of the small packets comprises a portion of the complete metadata such that when all of the information embedded in each of the packets is combined, they form the complete metadata information of the authentic image or video file.

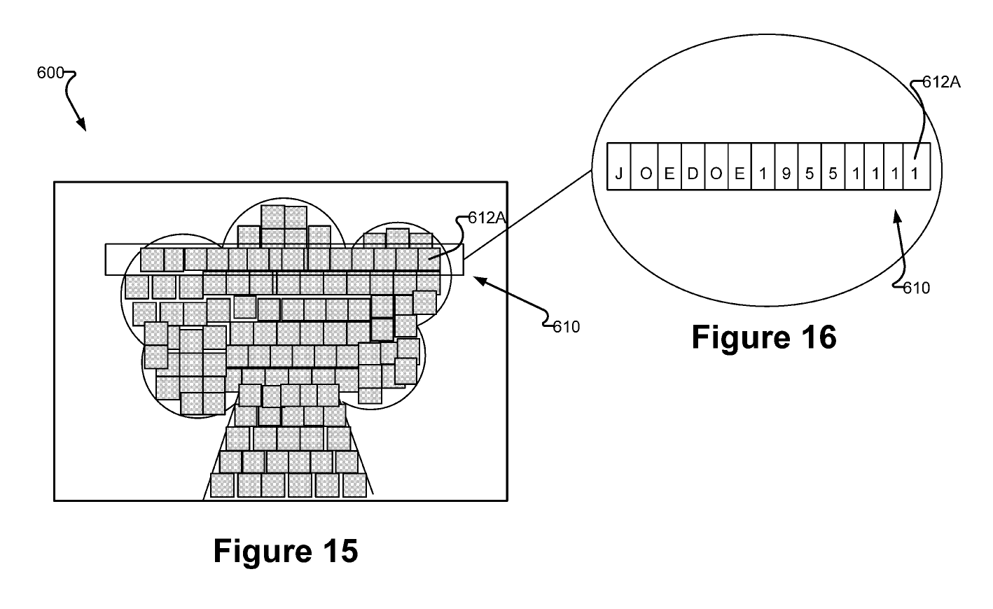

The complete metadata information of an image file may be separated by rows in which the small packets are positioned in the image. This is illustrated in FIGS. 15 and 16. FIG. 16 is an enlarged view of one row of small packets embedded within the image 600 of FIG. 15 captured by wearable device 12. Image 600 comprises small packets 612, distributed in rows within a specific region of image 600. In the embodiments shown in FIGS. 15 and 16, an enlarged row 610 of packets in FIG. 16 includes information such as the name and date of birth of the registered user assigned to the wearable device 12 from which the image 600 was taken (e. g. the name of the registered user is JOE DOE who was born on 11-11-1955). Each small packet 612A may include one letter or number, although this is not mandatory. Each small packet may include more than one letter or number to provide the same identification information. The other rows of packets may include information such as the birthplace of the user and the location (which may be expressed as altitude, latitude, and longitude). A skilled person will appreciate that there are many possible combinations to distribute the metadata information among small packets that are embedded at different locations within an image. In particular, the small packets may be distributed in any suitable pattern. In such an embodiment, the metadata information may be separated in any sensible way within the particular pattern of small packets so that even if the videos or images are cropped, the remaining portions will still be sufficient to provide the metadata information.

In some embodiments, visible digital watermarks are inserted in the image in addition to the small packets as detailed above. Such visible digital watermarks may be visible to human eyes. The visible digital watermarks may comprise the same information as the invisible small packet watermarks. In particular embodiments, the metadata information embedded in the image as visible digital watermarks may be positioned at the edges or corners of images or videos.

Server 100 may be configured to classify the images and videos in accordance with the metadata, such as by country, last and/or first names of the users taking the images or videos, birthplace of the users taking the images or videos, content of the images or videos, date and time of when the images or videos were taken, location where the images or videos were taken, etc. This may allow powerful and precise searching by various categories with descending or ascending orders.

Server 100 may include a facial recognition engine that automatically processes images and videos uploaded to database 104 for one or more of:
automatically comparing faces in the images or videos with persons of interest and notifying the relevant authorities when a match is found;
automatically recognizing people in images or videos who may also be users recognized by the system 10;

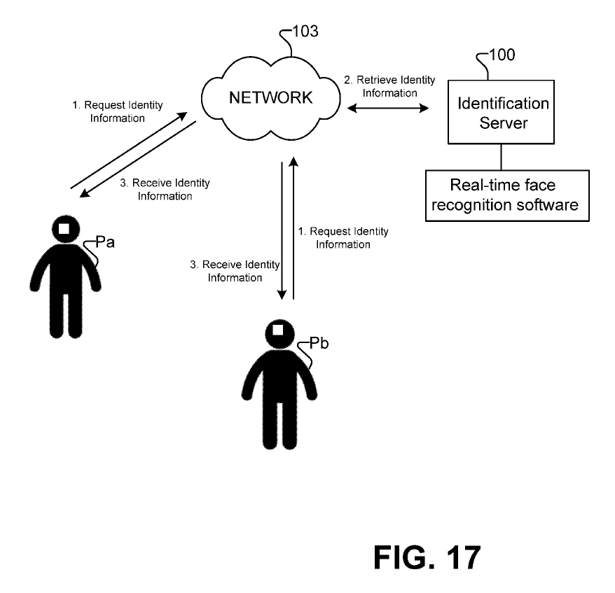

Wearable devices 12 may be capable of communicating with each other. For example, when two or more registered wearable devices 12 are within close proximity of each other, the two wearable devices 12 may communicate with one another. FIG. 17 shows a method for verifying the identities of registered users using the registered wearable devices 12 according to an example embodiment of the invention. In the illustrated embodiment, two users, user Pa and user Pb, are using or wearing their wearable devices 12a and 12b, respectively. When user Pa is within a preselected proximity of user Pb, user Pa or user Pb may command his or her own wearable device 12 to request verification of the other person's identity.

Such command may be made using any user interface modality provided by the wearable device 12. For example, the command may be a voice command picked up by microphone 24 of the wearable device 12, an input on an input device, through eyeball tracking, or the like. Upon receiving this command, the wearable computing device 12 activates an authentication program that may acquire one or more items of data for use in verifying the identity of the other person. Such items of data may include:
data identifying the wearable device 12 of the user whose identity is to be verified
   this may be acquired by wireless communication with the other device, either directly or mediated by server 100;
a facial image of the user whose identity is to be verified—this may be acquired using camera 26;
a recording of the voice of the user whose identity is to be verified—this may be acquired using microphone 24.

This information may be sent to server 100 either in a raw or processed form. Server 100 may use the information, and in combination with the information in database 104, to identify the authorized user corresponding to the information and to retrieve and provide personal information such as the name of the authorized user to the other authorized user who has requested the identity verification.

For example, the authentication program may comprise a facial recognition component. Upon activating the authentication program via voice command by user Pa, the facial recognition component automatically activates one or more cameras 26 in the wearable device 12. Cameras 26 begin capturing images of user Pb's face. Such image files are transmitted to server 100 via network 102. The server 100 uses the facial recognition component to compare the captured images with the images (or image recognition parameters) of all registered users stored in the database 104. After the process for authentication is complete, server 100 sends the identity information of user Pb to person Pa via network 102.

The two or more registered wearable devices 12 may further communicate with each other by wireless communication to exchange texts, photos, videos, location or other suitable information. Furthermore, it is possible for user Pa to see on his or her wearable device 12a the images and/or videos captured by user Pb on his or her wearable device 12b. This may be done in real time such that both users Pa and Pb are able to view the same images and/or videos at the same time. This is especially helpful for children who find themselves in dangerous situations.

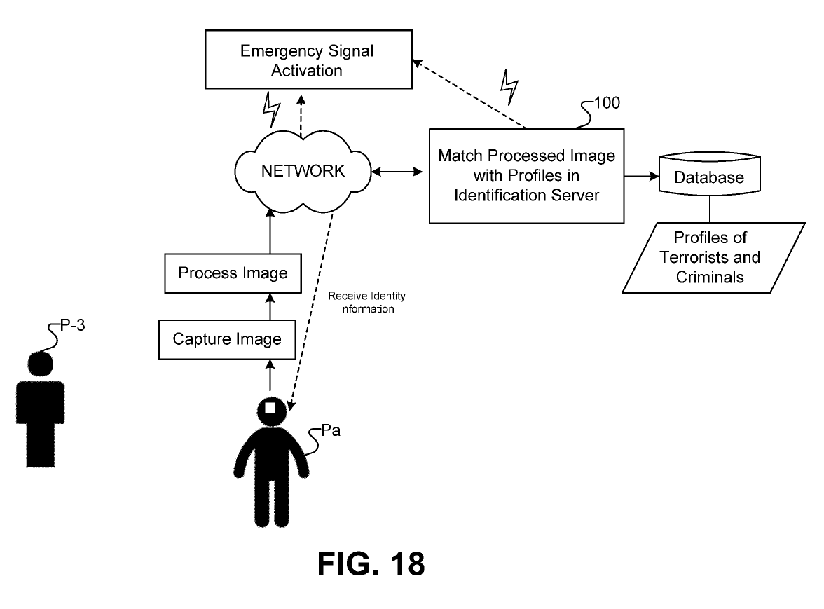

In some embodiments, the wearable device 12 may be capable of verifying the identities of individuals who are not registered users, as shown in FIG. 18. The database 104 may comprise identification information of both registered users of system 10 and other people of interest. The other people of interest may include, for example, known criminals.

The server 100 may also be linked to a database (not shown) of a law enforcement or national security agency so that the identification information of criminals may be automatically retrieved. Alternatively, the server 100 may request to retrieve identification information of criminals from one or more databases of law enforcement agencies. Such requests may be done at a predetermined time interval (e. g. daily, weekly, etc.). Identification information may include the face, voice, or fingerprint information of such individuals. Server 100 may search such identification information in addition to the identification information for registered users of system 10.

The cameras 26 of wearable devices 12 in such embodiments can serve as a network of scanners which can detect criminals. Each wearable device 12 acts like scanner or surveillance camera for these criminals among crowds. This also provides an element of safety for wearers of wearable devices 12, as they can avoid criminals or alert respective authorities when they are detected.

Referring to FIG. 18, when a registered user, user Pa, wearing or using his or her registered wearable device 12 within a predetermined proximity of non-user P-3, encounters an individual whom user Pa suspects to be a criminal, user Pa can command his or her wearable device 12 to check person P-3's identity. This activates the authentication program. Real-time authentication software in server 100 processes user Pa's captured images and attempts to match the captured images with the identification information accessible to server 100. If person P-3 is not identified by server 100, server 100 notifies user Pa, who may then decide to do nothing or to activate one or more emergency signals via wearable device 12. If person P-3 is verified to be a criminal, server 100 notifies user Pa, who may then choose to activate an emergency signal via wearable device 12 or simply get away.

If user Pa is a law enforcement officer looking for known criminals, wearable device 12-1 together with other devices 12-2, 12-3, etc. (not shown in FIG. 18) in the area can act jointly to scan people caught in images taken by the devices 12-1, 12-2, 12-3, etc.

Alternatively, server 100 may be configured to send messages to the nearest law enforcement personnel upon confirming that person P-3 is a criminal. Server 100 may also transmit the captured images with all the accompanying metadata to the law enforcement personnel. Having the metadata containing the identity of the criminal (i. e. person P-3) and the geographical location of the captured images, the law enforcement personnel can react promptly and appropriately.

In some embodiments, real-time authentication software is built or updated into each wearable device 12. In such embodiments, each wearable device 12 receives and stores identification information locally in memory 40, such as images of criminals. This identification information may be updated via the network 102 at intervals so that each wearable device 12 maintains up-to-date information. Once an image is captured by a user (such as person Pa), the real-time authentication software in wearable device 12 is activated and the software processes user Pa's captured images and attempts to match images of individuals in the captured images with the identification information stored in memory 40 of the wearable device 12. If a match is made, then the user of the wearable device 12 and/or the relevant authorities may be automatically notified as described above. Features as described above may be applied to locate missing children and other missing people.

As noted above, wearable devices 12, along with server 100 and database 104, as described herein form a system 10. Database 104 is preferably wirelessly accessible by the wearable devices 12 through server 100. Wearable devices 12 may transmit acquired media (e. g. images or videos) and audio recordings to server 100 for storage in database 104. Audio can be sorted and searched according the respective technology so that images or videos accompanied with music can also be searched and found by inputting similar audio. The wearable device 12 may send such media to database 104 automatically and/or in response to user commands. In some embodiments, some or all wearable devices 12 are configured to automatically periodically or continuously acquire and send media to database 104.

When database 104 receives media from the wearable device 12, database 104 may perform a number of functions (e. g. authentication of the received media). Authentication may, for example, verify a digital signature on videos or images corresponds to an authorized wearable device 12 and/or that the digital signature corresponds to the specific wearable device 12 from which the media was received as genuine. In some embodiments, database 104 may index the received media for sorting and searching using the metadata associated with the media. The metadata may include one or more or any combination of location, date and time, place with altitude, latitude, longitude and viewing direction at which the media was acquired, including but not limited to associated audio data like music melody, making the search more efficient.

Database 104 may process images through high-performance facial recognition software. In some embodiments, database 104 may compare any faces in the images to faces of the wanted people. Appropriate authorities may be automatically notified.

Police or other law enforcement agencies may search database 104. They may search for images recorded in certain areas at certain times and dates. In response to receiving an alert that a wanted person is depicted in an image acquired at a certain place and time the police may also search database 104 for other images acquired in the same general area at about the same time. In some embodiments, in response to detecting a match to a wanted person in a first image, database 104 automatically assembles a set of other media in database 104 that were acquired within a given time of the first image within a given distance of the location at which the first image was obtained.

Database 104 as described herein may provide many advantages for maintaining public safety. These include the following:
Database 104 includes the real name of each person who has a registered wearable device 12. Each media file in database 104 can be unambiguously and quickly associated with the specific person who was there when the image was acquired.
In some embodiments, police or another law enforcement agency may access the database 104 and communicate with users of wearable device 12 through server 100. The wearable device 12 can verify to the user that the communication is from an authorized person and is not from someone merely pretending to be a police officer because these security agencies have to register themselves on the system 10 beforehand.
A wide range of searches are possible. Such searches may be performed on demand or may be preset and run automatically. For example, database 104 can easily scan images acquired at a certain place or place facing in a certain direction to look for suspicious patterns. For example, database 104 may be programmed to identify any people who are repeatedly in the vicinity of a bank or other place at a certain time of day.
Another example of a type of search that may be performed is for all images that may depict a certain spot in a particular time range. This may be determined by processing metadata specifying the location, direction of view and field of view of images stored in database 104 to select images in which the target location may be visible and using metadata indicative of date and time of acquisition to limit the search results of/to a desired time range.
Public service announcements which may include warnings regarding things such as wanted people on the loose, weather warnings, tsunami warnings, earthquakes, etc. may be delivered by way of the wearable devices 12. In each case, users of the wearable devices 12 can trust that the public service announcements come from authorized sources.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While a number of exemplary aspects and embodiments are discussed herein, those of skills in the art will recognize certain modifications, permutations, additions and sub-combinations thereof. It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

I claim:

1. A method for registering a user with a wearable device, the method comprising:
accessing a server;
transmitting an identifier associated with the wearable device to the server;
verifying, by the server, that the identifier corresponds to the wearable device;
transmitting biometric information regarding the user to the server;
transmitting an image of the user to the server;
verifying, by the server, that the image of the user corresponds to the user;
linking, by the server, the biometric information of the user with the wearable device; and
receiving a message from the server indicating registration of the wearable device.

2. The method of claim 1, wherein the step of verifying, by the server, that the image of the user corresponds to the user comprises:
accessing, by the server, one or more trusted databases maintained by authorized trusted institutions; and
comparing, by the server, the image of the user with one or more trusted images of the user in the one or more trusted databases.

3. The method of claim 1, further comprising storing, by the server, the biometric information in one or more databases.

4. The method of claim 1, wherein the biometric information comprises one or more of the following: pulse, skeletal structure, voice pattern, iris patterns, retinal patterns, fingerprint, facial structure, body temperature, skin temperature, breathing patterns, or bioelectrical signals.

5. The method of claim 1, wherein the step of transmitting biometric information regarding the user to the server also comprises obtaining the biometric information regarding the user using the wearable device.

6. The method of claim 1, wherein the identifiers are marked on the wearable device.

7. The method of claim 2, wherein one or more trusted databases store trusted identifiers.

8. The method of claim 7, wherein the step of linking, by the server, the biometric information of the user with the wearable device comprises comparing the identifier with one or more of the trusted identifiers.

9. A method for authenticating a user of a particular wearable device, the method comprising:
obtaining, by the particular wearable device, one or more biometric readings of the user;
transmitting, by the particular wearable device, the one or more biometric readings to a server;
verifying, by the server, that the one or more biometric readings correspond to stored biometric readings for the user, wherein the stored biometric readings for the user are specific to the particular wearable device; and
transmitting, by the server, a message that the user is authenticated for the particular wearable device.

10. A system for wireless communications between two or more users, the system comprising:
a server;
a database in communication with the server;
two or more devices, each of the devices associated with one of the users and comprising:
one or more sensors for capturing biometric information regarding the associated user; and
one or more transceivers for communicating wirelessly with the server, wherein each of the devices may be worn by the associated user;
wherein the database comprises data regarding stored biometric information for each of the users; and
wherein each of the devices is adapted to transmit the captured biometric information to the server to verify that the captured biometric data corresponds to the stored biometric information for the associated user.

11. The system of claim 10, wherein the devices further comprise
a central frame;
two lens elements supported by the central frame; and
two arms extending from the central frame;
wherein the sensors and transceivers are mounted on one or both of the central frame and the arms.

12. The system of claim 11, wherein the devices further comprise one or more cameras, wherein the cameras are mounted on one or both of the central frame and the arms.

13. The system of claim 12, wherein the cameras are mounted proximate to an end of the arms.

14. The system of claim 11, wherein the devices further comprise one or more pads mounted on the central frame.

15. The system of claim 14, wherein the devices further comprise one or more microphones connected to the pads.

16. The system of claim 10, wherein the biometric information comprises one or more of the following: pulse, skeletal structure, voice pattern, iris patterns, retinal patterns, fingerprint, facial structure, body temperature, skin temperature, breathing patterns, or bioelectrical signals.

17. The system of claim 10, wherein the devices further comprise one or more speakers, wherein the speakers are mounted on one or both of the central frame and the arms.

18. The system of claim 17, wherein the speakers are mounted proximate to an end of the arms.

19. The system of claim 11, wherein the lens elements comprises one or more of the following: a substrate, a lens power source, and a display screen.

20. The system of claim 19, wherein the display screen includes touch screen functionality.

21. The system of claim 12, wherein the cameras are adapted to capture visual data.

22. The system of claim 21, wherein the visual data comprises one of the following:
images or videos.

23. The system of claim 22, wherein the visual data comprises metadata, the metadata comprising information regarding an identity of the user associated with the device, an elevation of the device when the visual data was captured, a time of when the visual data was captured, and a location of where the visual data was captured.

24. The system of claim 23, wherein the location includes an angle with respect to north or south.

25. The system of claim 24, wherein the metadata is not visible to the user.

26. The system of claim 25, wherein the metadata is embedded in the visual data in form of dots.

27. The system of claim 11, wherein opacity of the lens elements is adjustable.

28. The system of claim 11, wherein the lens elements comprise multiple layers.

29. The system of claim 12, wherein one or more of the cameras are oriented to capture videos of a rear view of the user.

30. The system of claim 29, wherein the videos are displayed on one or both of the lens elements.

31. The system of claim 12, wherein one or more of the cameras are oriented to capture videos of one or more retinal patterns of the user.

32. The system of claim 12, wherein one or more of the cameras are oriented to capture videos of movement of one or both of the user's eyeballs.

33. The system of claim 32, wherein the one or more of the cameras are mounted on an inner surface of the central frame.

34. The system of claim 21, wherein a first one of the devices is adapted to transmit the visual data to a second one of the devices for display on the lens elements of the second one of the devices.

35. The system of claim 10 further comprising one or more blocking devices, wherein the blocking devices block wireless communications between one or more of the devices and the server.
